(19) United States
(12) Patent Application Publication
(10) Pub. No.: US 2022/0348217 A1
(43) Pub. Date: Nov. 3, 2022

(54) ELECTRONIC APPARATUS FOR VEHICLES AND OPERATION METHOD THEREOF

(71) Applicant: LG Electronics Inc., Seoul (KR)

(72) Inventors: Sangkyeong JEONG, Seoul (KR); Hyunkyu KIM, Seoul (KR); Kibong SONG, Seoul (KR); Chulhee LEE, Seoul (KR); Junyoung JUNG, Seoul (KR)

(21) Appl. No.: 17/259,258

(22) PCT Filed: Aug. 23, 2019
(86) PCT No.: PCT/KR2019/010739

§ 371 Date: Jan. 11, 2021

(51) Int. Cl. B60W 50/14; B60W 40/06; B60W 40/04

(52) U.S. Cl. CPC B60W 50/14; B60W 40/06; B60W 40/04; B60W 2050/143; B60W 2050/146

(57) ABSTRACT

Disclosed is an electronic apparatus for vehicles, including; a processor configured to receive sensor data including an image of the outside of a vehicle, to identify a danger-factor from the sensor data through a first learning model, to learn a danger determination criterion depending on the danger-factor through a second learning model, and, when the danger-factor satisfies the danger determination criterion, to generate a warning signal for warning a user of presence of the danger-factor. One or more of the autonomous vehicle of the present disclosure, a user terminal and a server may be connected to or combined/integrated with an Artificial Intelligence module, an Unmanned Aerial Vehicle (UAV), such as a drone, a robot, an Augmented Reality (AR) apparatus, a virtual reality (VR) apparatus, an apparatus related to 5G service, etc.

### TECHNICAL FIELD

The present disclosure relates to an electronic apparatus for vehicles using artificial intelligence.

### BACKGROUND ART

In general, vehicles are apparatuses which a user may drive in a desired direction. An automobile is a representative example thereof. An autonomous vehicle means a vehicle which is capable of autonomously driving without human intervention.

Research on an Advanced Driver Assistance System (ADAS) for the purpose of convenience of vehicle users has been conducted vigorously, and for this purpose, various kinds of sensors and electronic apparatuses are provided. Various sensors conventionally installed in a vehicle are provided only for original functions of the vehicle. For example, a camera installed in the vehicle provides many pieces of data, such as a distance from a vehicle in front of the host vehicle, positions of objects, etc., but does not provide measures to analyze data and prevent danger for safety's sake.

That is, various pieces of data provided through the sensors mounted in the vehicle are complicated and unprocessed, and a driver experiences difficulty in analyzing the data to assess danger.

An artificial Intelligence (AI) system is a computer system which implements intelligence of a level of humans, and a system in which a machine itself becomes smarter through autonomous learning and determination, in contrast to a conventional rule-based smart system. As use of the AI system increases, a recognition ratio of the AI system is improved and the AI system more accurately understands user preferences, and thus, the conventional rule-based smart system has been gradually replaced with a deep learning-based AI system.

### DISCLOSURE

### Technical Problem

Therefore, the present disclosure has been made in view of the above problems, and it is an object of the present disclosure to provide a method which may learn information acquired through a sensor installed in a vehicle and then detect in advance a dangerous situation, which may occur during driving of the vehicle, using artificial intelligence technology.

It is a further object of the present disclosure to provide a method which may inform a driver of a detected dangerous situation and deal with the dangerous situation so that the driver may safely avoid the dangerous situation.

Objects of the present disclosure are not limited to the above-described objects, and other objects which are not stated above will be more clearly understood from the following detailed description.

### Technical Solution

In accordance with an aspect of the present disclosure, the above and other objects can be accomplished by the provision of an electronic apparatus for vehicles, including a processor configured to receive sensor data including an image of the outside of a vehicle, to identify a danger-factor from the sensor data through a first learning model, to learn a danger determination criterion depending on the danger-factor through a second learning model, and, when the danger-factor satisfies the danger determination criterion, to generate a warning signal for warning a user of presence of the danger-factor.

The processor may generate one or more corresponding control methods depending on the danger-factor through a third learning model, and learn a corresponding control method due to a user input signal out of the one or more corresponding control methods.

The processor may generate a corresponding control signal for controlling at least one vehicle drive apparatus of a steering control apparatus, a brake control apparatus or an acceleration control apparatus depending on the corresponding control method due to the user input signal.

The processor may calculate a safety grade of the corresponding control method due to the user input signal, based on position information, speed information and status information of the vehicle changed due to the corresponding control signal.

The processor in an autonomous driving mode may select a corresponding control method having a highest safety grade learned through the third learning model, from the one or more corresponding control methods, and control the at least one vehicle drive apparatus according to the corresponding control method having the highest safety grade.

The first learning model, the second learning model and the third learning model may include a Deep Neural Network (DNN) model being capable of learning position and time information.

The processor may, when the danger-factor identified through the first learning model satisfies the danger determination criterion learned through the second learning model, displays an icon stored depending on a kind of the danger-factor and the corresponding control method having the highest safety grade learned through the third learning model, on a Head Up Display (HUD) through augmented reality.

The processor may, when the processor generates the warning signal, transmit information about the danger-factor to one or more peripheral vehicles using Vehicle to Vehicle (V2V) communication.

The processor may generate a signal for displaying a corresponding control method for asking whether or not the vehicle is moved to a safe lane to avoid the danger-factor or whether or not the speed of the vehicle is changed to a driver as text or sound.

Peripheral object information may be acquired through a radar device or an ADAS camera of the vehicle, and kinds of objects and kinds of vehicles around the host vehicle may be detected and a degree of risk of respective lanes may be calculated using a trained DNN model.

A vehicle which changes lanes without operating turn signal lamps, or vehicle which drives without keeping its lane, may be detected using the trained DNN model, and a rear vehicle driver image may be acquired through a high-resolution camera so as to determine whether or not the rear vehicle driver is in a drowsy driving state or a state neglecting forward attention.

A road state may be confirmed by a front camera of the vehicle, a damaged road surface may be detected using the trained DNN model, and, when the host vehicle enters a road having the damaged road surface, a warning may be provided or a corresponding region may be displayed trough augmented reality.

Front vehicle information may be acquired by the front camera of the vehicle, a truck may be detected using the trained DNN model, a height for safe driving may be extracted, and, upon determining that the truck is an overloaded vehicle, the overloaded vehicle may be displayed as a dangerous vehicle or a danger radius of the overloaded vehicle may be displayed.

A degree of symmetry and a degree of shaking of cargo loaded on a preceding vehicle may be extracted using the trained DNN model.

Whether or not a brake pedal of a front vehicle is pressed may be determined and whether or not brake lights of the front vehicle are normally operated may be detected simultaneously using the trained DNN model.

The driver may be safely guided to a destination while avoiding a recklessly driving vehicle on a commuting path using a commuting path DB and a recklessly driving vehicle DB in the vehicle, real-time image information of the front and rear cameras of the vehicle, a navigation moving path, and AI technology.

A road situation and dangerous object emergence situations in respective sections may be learned through day and time, driving speed information and front and rear image information in a current driving section, a congested road or a children protection zone may be recognized in advance based on the trained model, and information about a dangerous object frequent emergence section may be provided in advance to the driver.

Details of other aspects will be included in the following description and drawings.

### Advantageous Effects

An electronic apparatus for vehicles in accordance with the present disclosure has one or more of the following effects.

First, the electronic apparatus for vehicles may accurately identify an object through a configuration for identifying one or more objects based on a trained DNN model.

Second, the electronic apparatus for vehicles may use sensor data as data for detecting in advance a dangerous situation which may occur during driving, through a configuration for determining whether or not an object is a danger-factor based on the trained DNN model.

Third, the electronic apparatus for vehicles may secure driver safety through a configuration for displaying a corresponding control method depending on a danger-factor.

Fourth, the electronic apparatus for vehicles may cope with a dangerous situation, which a driver cannot recognize, through a configuration for generating a corresponding control signal.

Fifth, the electronic apparatus for vehicles may reduce a time taken to analyze data by the driver through processed sensor data, thereby allowing the driver to rapidly recognize and rapidly cope with a dangerous situation.

Effects of the present disclosure are not limited to the above-described effects, and various other effects of the disclosure will be directly or implicitly set forth in the following detailed description and the accompanying claims.

### DESCRIPTION OF DRAWINGS

FIG. 1 is a view illustrating the external appearance of a vehicle in accordance with one embodiment of the present disclosure.

FIG. 2 is a control block diagram of the vehicle in accordance with one embodiment of the present disclosure.

FIG. 3 is a control block diagram of an electronic apparatus in accordance with one embodiment of the present disclosure.

FIG. 4 is a view illustrating cameras mounted in the vehicle in accordance with one embodiment of the present disclosure.

FIG. 5 is a flowchart of a processor in accordance with one embodiment of the present disclosure.

FIG. 6 is a flowchart representing generation of a corresponding control method in accordance with one embodiment of the present disclosure.

FIGS. 7A and 7B are reference views assisting understanding of transmission of signals through V2V communication in accordance with one embodiment of the present disclosure.

FIG. 8 is a view illustrating kinds of danger-factors, kinds of lanes in which the danger-factors are present, and degrees of risk of the danger-factors in accordance with one embodiment of the present disclosure.

FIG. 9 is a view illustrating a rear vehicle driving without keeping its lane, which is detected from a rear image of the vehicle in accordance with one embodiment of the present disclosure.

FIG. 10 is a view illustrating a vehicle having failure of brake lights, which is detected from a front image of the vehicle in accordance with one embodiment of the present disclosure.

FIGS. 11A and 11B are views illustrating a damaged road surface, which is detected from a front image of the vehicle in accordance with one embodiment of the present disclosure.

FIGS. 12A to 12C are views illustrating a truck, which is detected from a front image of the vehicle in accordance with one embodiment of the present disclosure.

FIG. 13 is a flowchart illustrating search and guidance of a recklessly driving vehicle.

FIG. 14 is a flowchart illustrating search and guidance of a congested road section.

FIG. 15 is a view illustrating notification through RGB LEDs.

FIGS. 16A to 16C are views illustrating display of icons depending on kinds of danger-factors using augmented reality.

FIG. 17 is a view illustrating guidance of the vehicle to a safe lane to avoid a danger-factor.

FIG. 18 is a view illustrating one example of basic operations of an autonomous vehicle and a 5G network in a 5G communication system.

FIG. 19 is a view illustrating one example of application operations of the autonomous vehicle and the 5G network in the 5G communication system.

FIGS. 20 to 23 are flowcharts, each of which represents one example of the operation of the autonomous vehicle using 5G communication.

### BEST MODE

Hereinafter, embodiments of the present disclosure will be described in detail with reference to the accompanying drawings, and the same or similar elements are denoted by the same reference numerals even though they are depicted in different drawings, and redundant description thereof will thus be omitted. In the following description of the embodiments, it will be understood that the suffixes “module” and “unit” added to elements are used in consideration only of ease in preparation of the description, and the terms themselves do not indicate important significances or roles. Therefore, the suffixes “module” and “unit” may be used interchangeably. In addition, in the following description of the present disclosure, a detailed description of known functions and configurations incorporated herein will be omitted when it may make the subject matter of the present disclosure rather unclear. While the disclosure will be described in conjunction with exemplary embodiments, it will be understood that the present description is not intended to limit the disclosure to the exemplary embodiments.

In addition, in the following description of the embodiments, the terms “first”, “second”, etc. may be used to describe various elements, and it will be understood that these terms do not limit the corresponding elements. It will be understood that these terms are used only to distinguish one element from other elements.

In the following description of the embodiments, it will be understood that, when an element is “connected to”, “coupled to”, etc. another element, the two elements may be directly connected or coupled, or one or more other elements may be interposed between the two elements. On the other hand, it will be understood that, when an element is “directly connected to”, “directly coupled to”, etc. another element, no elements may be interposed between the two elements.

A singular expression of an element encompasses a plural expression of the element, unless stated otherwise.

In the following description of the embodiments, the terms “including”, “having”, etc. will be interpreted as indicating the presence of characteristics, numbers, steps, operations, elements or parts stated in the specification or combinations thereof, and do not exclude the presence of one or more characteristics, numbers, steps, operations, elements, parts or combinations thereof, or a possibility of adding the same.

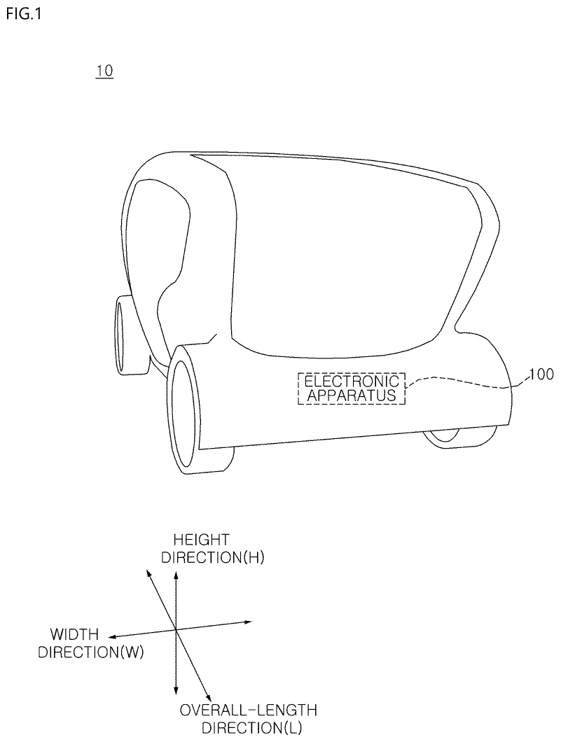

FIG. 1 is a view illustrating a vehicle in accordance with one embodiment of the present disclosure.

Referring to FIG. 1, a vehicle 10 in accordance with one embodiment of the present disclosure is defined as a transportation means which runs on roads or railroads. The vehicle 10 conceptually includes an automobile, a train, and a motorcycle. The vehicle 10 may conceptually include an internal combustion vehicle provided with an engine as a power source, a hybrid vehicle provided with both an engine and an electric motor as power sources, an electric vehicle provided with an electric motor as a power sources, etc. The vehicle 10 may be a shared vehicle. The vehicle 10 may be an autonomous vehicle.

The vehicle 10 may include an electronic apparatus 100. The electronic apparatus 100 may be an apparatus which may detect danger-factors occurring during driving of the vehicle 10 and provide a corresponding control method so as to secure driver safety.

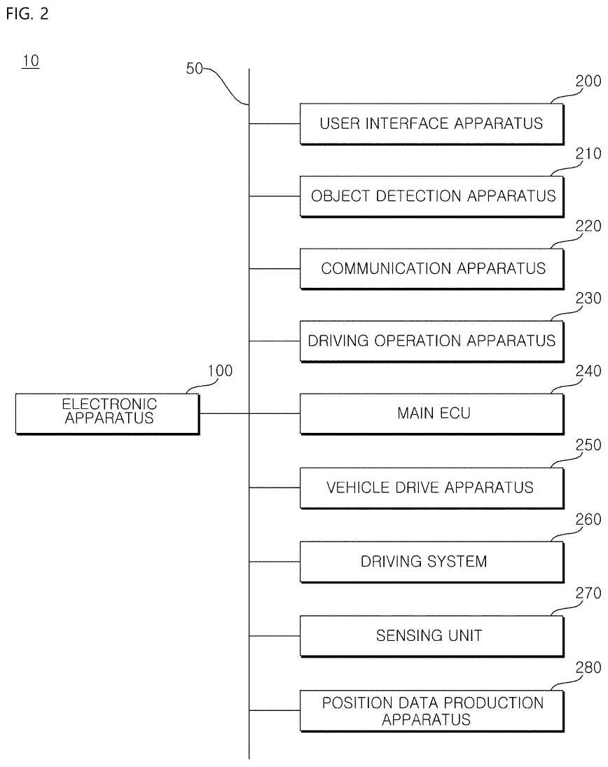

FIG. 2 is a control block diagram of the vehicle in accordance with one embodiment of the present disclosure.

Referring to FIG. 2, the vehicle 10 may include the electronic apparatus 100 for vehicles, a user interface apparatus 200, an object detection apparatus 210, a communication apparatus 220, a driving operation apparatus 230, a main ECU 240, a vehicle drive apparatus 250, a driving system 260, a sensing unit 270 and a position data generation apparatus 280.

The electronic apparatus 100 may receive sensor data acquired through the sensing unit 270. The electronic apparatus 100 may detect an object through the object detection apparatus 210. The electronic apparatus 100 may exchange data with peripheral vehicles through the communication apparatus 220. The electronic apparatus 100 may warn of a dangerous situation through an output unit and display a corresponding control method. In this case, a microphone, a speaker and a display provided in the vehicle 10 may be used. The microphone, the speaker and the display provided in the vehicle 10 may be a sub-element of the user interface apparatus 200. The electronic apparatus 100 may control safe driving of the vehicle through the vehicle drive apparatus 250.

The user interface apparatus 200 is an apparatus for communication between the vehicle 10 and a user. The user interface apparatus 200 may receive user input and provide information generated by the vehicle 10 to the user. The vehicle 10 may implement a user interface (UI) or a user experience (UX) through the user interface apparatus 200.

The user interface apparatus 200 may include an input unit and the output unit.

The input unit serves to receive information from the user, and data collected by the input unit may be processed as a user's control command. The input unit may include a voice input unit, a gesture input unit, a touch input unit and a mechanical input unit. The output unit serves to generate visual, auditory or haptic output, and may include at least one of a display unit, an acoustic output unit or a haptic output unit.

The display unit may display graphic objects corresponding to various pieces of information. The display unit may include at least one of a liquid crystal display (LCD), a thin film transistor-liquid crystal display (TFT LCD), an organic light-emitting diode (OLED), a flexible display, a 3D display, or an e-ink display.

The display unit and a touch input unit may form a layered structure or be integrated, thus being capable of implementing a touch screen. The display unit may be implemented as a Head Up Display (HUD). In this case, a projection module may be provided so as to output information through an image projected on a windshield or a window. The display unit may include a transparent display. The transparent display may be adhered to the windshield or the window.

The display unit may be disposed in one region of a steering wheel, one region of an instrument panel, one region of a seat, one region of each pillar, one region of a door, one region of a center console, one region of a head lining, one region of a sun visor, one region of the windshield, or one region of the window.

The user interface apparatus 200 may include a plurality of display units.

The acoustic output unit converts an electrical signal provided from a processor 170 into an audio signal. For this purpose, the acoustic output unit may include one or more speakers.

The haptic output unit may generate haptic output. For example, the haptic output unit may vibrate the steering wheel, a safety belt or a seat so that a user may recognize output.

The user interface apparatus 200 may be referred to as a display apparatus for vehicles.

The object detection apparatus 210 may detect objects outside the vehicle 10. The object detection apparatus 210 may include at least one sensor which may detect objects outside the vehicle 10. The object detection apparatus 210 may include at least one of a camera 130, a radar device, a lidar device, an Ultrasonic sensor or an infrared sensor. The object detection apparatus 210 may provide data about objects, generated based on a sensing signal generated by the sensor, to at least one electronic apparatus included in the vehicle.

The objects may be various objects relating to driving of the vehicle 10. For example, the objects may include lanes, other vehicles, pedestrians, two-wheeled vehicles, traffic signs, light, roads, structures, speed bumps, landmarks, animals, etc.

The objects may be classified into movable objects and stationary objects. For example, the movable objects may conceptually include other vehicles and pedestrians, and the stationary objects may conceptually include traffic signs, roads and structures.

The camera 130 may be located at a proper position of the vehicle so as to acquire an image outside the vehicle. The camera may be a mono camera, a stereo camera, an Around View Monitoring (AVM) camera or a 360-degree camera.

The camera 130 may acquire position information of an object, distance information from the object and relative speed information to the object, using various image processing algorithms.

For example, the camera 130 may acquire distance information from an object and relative speed information to the object based on a change in the size of the object according to time, from an acquired image.

For example, the camera 130 may acquire distance information from an object and relative speed information to the object through a pin hole model, road profiling, etc.

For example, the camera 130 may acquire distance information from an object and relative speed information to the object based on disparity information in a stereo image acquired by a stereo camera.

The radar device may include an electromagnetic wave transmitter and an electromagnetic wave receiver. The radar device may be implemented through a pulse radar method or a continuous wave radar method according to a wave emission principle. The radar device may be implemented through a frequency modulated continuous wave (FMCW) method or a frequency shift keyong (FSK) method among the continuous wave radar method according to a signal waveform.

The radar device may detect an object, and detect a position of the detected object, a distance from the detected object and a relative speed to the detected object, based on a time of flight (TOF) method or a phase-shift method.

The radar device may be disposed at a proper position of the exterior of the vehicle so as to sense an object located in front of, at the rear of, or at the side of the vehicle.

The lidar device may include a laser transmitter and a laser receiver. The lidar device may be implemented through a time of flight (TOF) method or a phase-shift method.

The lidar device may be implemented in a driven manner or a non-driven manner. If the lidar device is implemented in the driven manner, the lidar device may be rotated by a motor and thus detect an object around the vehicle 10. If the lidar device is implemented in the non-driven manner, the lidar device may detect an object located within a designated range from the vehicle 10 through beam steering. The vehicle 10 may include a plurality of non-driven lidar devices.

The lidar device may detect an object, and detect a position of the detected object, a distance from the detected object and a relative speed to the detected object via laser light, based on the time of flight (TOF) method or the phase-shift method.

The lidar device may be disposed at a proper position of the exterior of the vehicle so as to sense an object located in front of, at the rear of, or at the side of the vehicle.

The ultrasonic sensor may include an Ultrasonic transmitter and an Ultrasonic receiver. The ultrasonic sensor may detect an object, and detect a position of the detected object, a distance from the detected object and a relative speed to the detected object, based on ultrasonic waves.

The ultrasonic sensor may be disposed at a proper position of the exterior of the vehicle so as to sense an object located in front of, at the rear of, or at the side of the vehicle.

The infrared sensor may include an infrared transmitter and an infrared receiver. The infrared sensor may detect an object, and detect a position of the detected object, a distance from the detected object and a relative speed to the detected object, based on infrared light.

The infrared sensor may be disposed at a proper position of the exterior of the vehicle so as to sense an object located in front of, at the rear of, or at the side of the vehicle.

Object information may include information about whether or not an object is present, position information of the object, distance information between the vehicle 10 and the object, and relative speed information between the vehicle 10 and the object.

The communication apparatus 220 may exchange signals with a device located outside the vehicle 10. The communication apparatus 220 may exchange signals with at least one of infrastructure (for example, a server and a broadcasting station) or other vehicles. The communication apparatus 220 may include at least one of a transmission antenna, a reception antenna, and a radio frequency (RF) circuit, which may implement various communication protocols, or an RF device.

The communication apparatus 220 may include a short-range communication unit, a position information unit, a V2X communication unit, an optical communication unit, a broadcast transceiving unit, and an Intelligent Transport Systems (TIS) communication unit.

The V2X communication unit is a unit to perform wireless communication with a server (vehicle to infra: V2I), another vehicle (vehicle to vehicle: V2V) or a pedestrian (vehicle to pedestrian: V2P). The V2X communication unit may include an RF circuit which may implement a V2I, V2V or V2P communication protocol.

The vehicle 10 may exchange information about danger-factors, including kind and position information of the danger-factors, with one or more peripheral vehicles through V2V communication. Further, the vehicle 10 may exchange signals regarding corresponding control methods with the peripheral vehicles through V2V communication. The peripheral vehicles may prepare for a dangerous situation by receiving the signals regarding the danger-factors and the corresponding control methods.

The communication apparatus 220 and the user interface apparatus 200 may implement a display apparatus for vehicles. In this case, the display apparatus for vehicles may be referred to as a telematics apparatus or an Audio, Video and Navigation (AVN) apparatus.

The driving operation apparatus 230 is an apparatus which receives user input for driving. In a manual mode, the vehicle 10 may be driven based on a signal provided by the driving operation apparatus 230. The driving operation apparatus 230 may include a steering input device (for example, a steering wheel), an acceleration input device (for example, an accelerator pedal), and a brake input device (for example, a brake pedal).

The main ECU 240 may control the overall operation of at least one electronic apparatus included in the vehicle 10.

The drive control apparatus 250 is a device which electrically controls various vehicle drive apparatuses in the vehicle 10. The drive control apparatus 250 may include a powertrain drive control apparatus, a chassis drive control apparatus, a door/window drive control apparatus, a safety apparatus drive control apparatus, a lamp drive control apparatus and an air conditioner drive control apparatus.

The powertrain drive control apparatus may include a power source drive control apparatus and a transmission drive control apparatus.

The power source drive control apparatus may perform control of power sources of the vehicle 10. For example, if a fossil fuel-based engine is used as a power source, the power source drive control apparatus may perform electronic control of the engine. Thereby, the power source drive control apparatus may control output torque of the engine.

For example, if an electrical energy-based motor is used as a power source, the power source drive control apparatus may perform control of the motor, and adjust a rotational speed, a torque, etc. of the motor under the control of the processor 170.

The transmission drive control apparatus may perform control of a transmission, and adjust the state of the transmission to a gear position indicating a drive (D), reverse (R), neutral (N) or parking (P) mode.

The chassis drive control device may control operations of chassis devices, and include a steering drive control apparatus, a brake drive control apparatus and a suspension drive control apparatus.

The steering drive control apparatus may perform electronic control of a steering apparatus in the vehicle 10 and thus change the driving direction of the vehicle.

The brake drive control apparatus may perform electronic control of a braking apparatus in the vehicle 10. For example, the brake drive control apparatus may control operation of a brake disposed at a wheel so as to reduce the speed of the vehicle 10.

The suspension drive control apparatus may perform electronic control of a suspension apparatus in the vehicle 10. For example, if a road is curved, the suspension drive control apparatus may control the suspension apparatus so as to reduce the vibration of the vehicle 10.

The safety apparatus drive control apparatus may include a safety belt drive control apparatus to control a safety belt.

The drive control apparatus 250 may be referred to as a control electronic control unit (ECU).

The driving system 260 may control movement of the vehicle 10 or generate a signal outputting information to the user, based on data about objects received from the object detection apparatus 210. The driving system 260 may provide the generated signal to at least one of the user interface apparatus 200, the main ECU 240 or the vehicle drive apparatus 250.

The driving system 260 may conceptually include an Advanced Driver Assistance System (ADAS). The ADAS 260 may implement at least one of an Adaptive Cruise Control (ACC) system, an Autonomous Emergency Braking (AEB) system, a Forward Collision Warning (FCW) system, a Lane-Keeping Assist (LKA) system, a Lane Change Assist (LCA) system, a Target Following Assist (TFA) system, a Blind-Spot Detection (BSD) system, an adaptive High-Beam Assist (HBA) system, an Auto Parking System (APS), a pedestrian (PD) collision warning system, a Traffic-Sign Recognition (TSR) system, a Traffic-Sign Assist (TSA) system, a Night Vision (NV) system, a Driver Status Monitoring (DSM) system, or a Traffic-Jam Assist (TJA) system.

The driving system 260 may include an autonomous driving Electronic Control Unit (ECU). The autonomous driving ECU may set an autonomous driving path based on data received from at least one of other electronic apparatuses inside the vehicle 10. The autonomous driving ECU may set the autonomous driving path based on data received from at least one of the user interface apparatus 200, the object detection apparatus 210, the communication apparatus 220, the sensing apparatus 270 or the position data generation apparatus 280. The autonomous driving ECU may generate a control signal so that the vehicle 10 drives along the autonomous driving path. The control signal generated by the autonomous driving ECU may be provided to at least one of the main ECU 240 or the vehicle drive apparatus 250.

The sensing unit 270 may sense a status of the vehicle. The sensing unit 270 may include at least one of an inertial navigation unit (IMU) sensor, a crash sensor, a wheel sensor, a speed sensor, a tilt sensor, a weight sensor, a heading sensor, a position module, a vehicle forward/backward driving sensor, a battery sensor, a fuel sensor, a tire sensor, a steering sensor for sensing rotation of a steering wheel, a vehicle indoor temperature sensor, a vehicle indoor humidity sensor, an Ultrasonic sensor, an illumination sensor, an accelerator pedal position sensor or a brake pedal position sensor. The inertial navigation unit (IMU) sensor may include one or more of an acceleration sensor, a gyro sensor and a magnetic sensor.

The sensing unit 270 may generate status data of the vehicle based on a signal generated by the at least one sensor. The sensing unit 270 may acquire sensing signals to vehicle posture information, vehicle motion information, vehicle yaw information, vehicle roll information, vehicle pitch information, vehicle collision information, vehicle direction information, vehicle angle information, vehicle speed information, vehicle acceleration information, vehicle tilt information, vehicle forward/backward driving information, battery information, fuel information, tire information, vehicle lamp information, vehicle indoor temperature information, vehicle indoor humidity information, a steering wheel rotation angle, vehicle outdoor illumination, a pressure applied to the accelerator pedal, a pressure applied to the brake pedal, etc.

The sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a top dead center (TDC) sensor, a crank angle sensor (CAS), etc.

The sensing unit 270 may generate vehicle status information based on the sensing data. The vehicle status information may be information generated based on data sensed by various sensors provided in the vehicle.

For example, the vehicle status information may include posture information of the vehicle, speed information of the vehicle, tilt information of the vehicle, weight information of the vehicle, direction information of the vehicle, battery information of the vehicle, fuel information of the vehicle, tire pressure information of the vehicle, steering information of the vehicle, vehicle indoor temperature information, vehicle indoor humidity information, pedal position information, vehicle engine temperature information, etc.

The sensing unit may include a tension sensor. The tension sensor may generate a sensing signal based on the tension state of a safety belt.

The position data generation apparatus 280 may generate position data of the vehicle 10. The position data generation apparatus 280 may include at least one of a Global Positioning System (GPS) or a Differential Global Positioning System (DGPS). The position data generation apparatus 280 may generate the position data of the vehicle 10 based on a signal generated by at least one of the GPS or the DGPS. In accordance with embodiments, the position data generation apparatus 280 may correct the position data based on at least one of an Inertial Measurement Unit (IMU) of the sensing unit 270 or a camera of the object detection apparatus 210.

The position data generation apparatus 280 may be referred to as a location positioning device. The position data generation apparatus 280 may be referred to a Global Navigation Satellite System (GNSS).

The vehicle 10 may include an internal communication system 50. A plurality of electronic apparatuses included in the vehicle 10 may exchange signals via the internal communication system 50. The signals may include data. The internal communication system 50 may use at least one communication protocol (for example, CAN, LIN, FlexRay, MOST, and/or Ethernet).

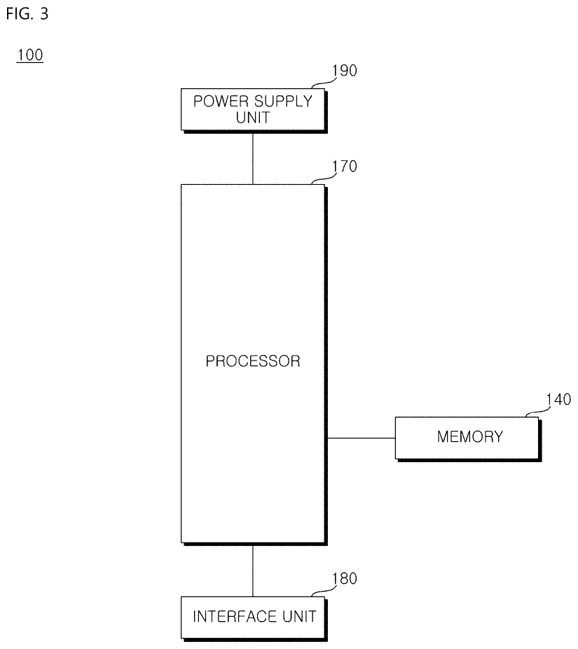

FIG. 3 is a control block diagram of the electronic apparatus in accordance with one embodiment of the present disclosure.

Referring to FIG. 3, the electronic apparatus 100 may include a memory 140, the processor 170, an interface unit 180 and a power supply unit 190. The electronic apparatus 100 may include at least one printed circuit board (PCB). The memory 140, the interface unit 180, the power supply unit 190 and the processor 170 may be electrically connected to the printed circuit board.

The memory 140 is electrically connected to the processor 170. The memory 140 may store primary data for units, control data for controlling operations of the units, and input and output data. The memory 140 may store data processed by the processor 170. The memory 140 may include at least one of a ROM, a RAM, an EPROM, a flash drive or a hard drive, from the aspect of hardware. The memory 140 may store various pieces of data for overall operation of the electronic apparatus 100, including programs to perform processing and control through the processor 170. The memory 140 may be implemented integrally with the processor 140. In accordance with embodiments, the memory 140 may be classified as a sub-element of the processor 170.

The memory 140 may store image data generated by the camera 130. If the processor 170 determines that a second user invades a virtual barrier, the memory 140 may store image data which is a criterion of the determination.

The interface unit 180 may exchange signals with at least one electronic apparatus provided in the vehicle 10 by wire or wirelessly. The interface unit 180 may exchange signals with at least one of the object detection apparatus 210, the communication apparatus 220, the driving operation apparatus 230, the main ECU 240, the vehicle drive apparatus 250, the ADAS 260, the sensing unit 270 or the position data generation apparatus 280 by wire or wirelessly. The interface unit 280 may include at least one of a communication module, a terminal, a pin, a cable, a port, a circuit, an element or a device.

The interface unit 180 may receive position data of the vehicle 10 from the position data generation apparatus 280. The interface unit 180 may receive driving speed data from the sensing unit 270. The interface unit 180 may receive data about objects around the vehicle from the object detection apparatus 210.

The interface unit 180 may be used to transmit a signal regarding a corresponding control method for securing driver safety in response to a danger-factor generated by the processor 170, to the output unit.

The power supply unit 190 may supply power to the electronic apparatus 100. The power supply unit 190 may receive power from a power source (for example, the battery) included in the vehicle 10, and supply the power to the respective units of the electronic apparatus 100. The power supply unit 190 may be operated by a control signal provided by the main ECU 140. The power supply unit 190 may be implemented as a switched-mode power supply (SMPS).

The processor 170 may be electrically connected to the memory 140, the interface unit 180 and the power supply unit 190, and thus exchange signals with the same. The processor 170 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions.

The processor 170 may be driven by power provided by the power supply unit 190. The processor 170 may receive data, process the data, generate a signal and provide the signal, under the condition that power is supplied from the power supply unit 190 to the processor 170.

The processor 170 may receive information from other electronic apparatuses inside the vehicle 10 through the interface unit 180. The processor 170 may provide control signals to other electronic apparatuses inside the vehicle 10 through the interface unit 180.

The processor 170 may receive sensor data, identify a danger-factor based on the sensor data, learn a danger determination criterion of each danger-factor, and generate a signal warning a user about presence of the danger-factor, when the danger-factor satisfies the danger determination criterion.

The processor 170 may receive sensor data sensed by the sensing unit 270 or the object detection apparatus 210 through the interface unit 180. The sensor data may include an image of the outside of the vehicle, acquired through the radar device or the camera.

The processor 170 may acquire front object information, rear object information including rear vehicles, and peripheral information from the sensor data.

The processor 170 may detect or identify one or more danger-factors based on the sensor data.

For example, the processor 170 may identify a vehicle which changes lanes without operating turn signal lamps, a vehicle which drives without keeping its lane, a damaged road surface, kinds of lanes, a truck, a decelerating vehicle, etc.

The processor 170 may identify a danger-factor from the sensor data through a first learning model. In this case, the first learning model may be a trained DNN model.

A Deep Neural Network (DNN) means an Artificial Neural Network (ANN) including multiple hidden layers between an input layer and an output layer.

The processor 170 may learn the danger determination criterion of each danger-factor, so as to determine whether or not the detected danger-factor satisfies the danger determination criterion.

The processor 170 may learn the danger determination criterion depending on the danger-factor through a second learning model. In this case, the second learning model may be a trained DNN model.

The processor 170 may identify kinds of objects, including kinds of vehicles, and kinds of lanes from the image of the outside of the vehicle through the first learning model, and learn degrees of risk of the kinds of the objects and the kinds of the lanes used as parameters through the second learning model.

The processor 170 may identify a vehicle, which changes lanes without operating turn signal lamps, or a vehicle, which drives without keeping its lane, from a rear image of the vehicle through the first learning model, acquire a rear vehicle driver image through the camera, and learn the status of the rear vehicle driver from the rear vehicle driver image through the second learning model.

The processor 170 may identify a damaged road surface and a kind of a lane, from a front image of the vehicle through the first learning model, and learn a degree of shaking of the vehicle during driving through the second learning model.

The processor 170 may identify at least one of a kind of a truck or a degree of symmetry of cargo loaded on the truck from a front image of the vehicle though the first learning model, and learn height information due to the kind of the truck or a degree of shaking of the truck due to the degree of symmetry of the cargo loaded on the truck through the second learning model.

The processor 170 may identify a front vehicle which is being decelerated from a front image of the vehicle through the first learning model, and learn whether or not brake lights are operated due to deceleration of the front vehicle through the second learning model.

The processor 170 may determine whether or not a danger-factor satisfies a danger determination criterion, and generate a signal for warning about presence of the danger-factor, when the danger-factor satisfies the danger determination criterion. The warning signal may be a signal which displays a kind and position of the danger-factor, and a degree of risk of the danger-factor through the display unit.

The processor 170 may digitize the degree of risk, and generate a warning signal for displaying the kind of the object and the digitized degree of risk, and a warning signal for displaying a color stored according to the degree of risk through RGB LEDs installed in the vehicle, when the digitized degree of risk is a set value or more.

The processor 170 may determine that a rear vehicle driver is in a drowsy driving state when an eye blinking speed of the rear vehicle driver is a set value or less, determine that the rear vehicle driver is in a state neglecting forward attention when a gaze direction of the rear vehicle driver is not a forward direction, and generate a warning signal for displaying the drowsy driving state or the state neglecting forward attention.

The processor 170 may store a front image of a vehicle together with position information when a degree of shaking of the vehicle is a set value or more, generate a first warning signal when the vehicle enters the position information within a predetermined distance, and generate a second warning signal when a damaged road surface is identified from the front image of the vehicle.

The processor 170, when height information is a value, which is set depending on a kind of a truck, or more or a degree of shaking of the truck is a set value or more, may calculate a danger radius, which is a fall range of cargo from the truck based on the height information and the degree of shaking, and generate a warning signal for displaying the truck and the danger radius.

The processor 170, upon determining that brake lights of a front vehicle are not operated during deceleration of the front vehicle, may display the brake lights of the front vehicle as being turned on during deceleration of the front vehicle through augmented reality (AR) and generate a warning signal for indicating a defect of the brake lights.

The processor 170 may display the position of a danger-factor through a signal for displaying the position of a lane in which the danger-factor is located. The processor 170 may display the position of the danger-factor by storing lanes as being expressed in different colors and displaying the color of the lane in which the danger-factor is located.

The processor 170 may generate one or more corresponding control methods for securing driver safety in response to the danger-factor.

The processor 170 may generate one or more corresponding control methods according to the danger-factor through a third learning model. In this case, the third learning model may be a trained DNN model.

The processor 170 may generate one or more corresponding control methods according to the danger-factor through the third learning model, and determine whether or not an autonomous driving mode is executed. Upon determining that the autonomous driving mode is not executed, the processor 170 may receive a user input signal, and learn a corresponding control method in response to the user input signal among the one or more corresponding control methods.

The processor 170 may generate a corresponding control signal for controlling at least one vehicle drive apparatus of the braking apparatus, the steering apparatus or an accelerating apparatus depending on the corresponding control method in response to the user input signal.

The processor 170 may calculate a safety grade of the corresponding control method selected by the user based on the position information, speed information and status information of the vehicle which are changed according to the corresponding control signal.

Upon determining that the autonomous driving mode is executed, the processor 170 may select a corresponding control method having the highest safety grade learned through the third learning model, from the one or more corresponding control methods. The processor 170 may control the vehicle drive apparatus depending on the corresponding control method having the highest safety grade.

The processor 170 may generate a corresponding control signal for controlling at least one vehicle drive apparatus of the braking apparatus, the steering apparatus or the accelerating apparatus depending on the corresponding control method having the highest safety grade.

When the danger-factor identified through the first learning model satisfies the danger determination criterion learned through the second learning model, the processor 170 may generate a signal for displaying an icon stored according to the kind of the danger-factor and the corresponding control method having the highest safety grade learned through the third learning model, on the Head Up Display (HUD) through augmented reality.

The processor 170 may generate a signal for calculating and displaying a degree of risk. The degree of risk may be defined as a possibility of occurrence of an accident of the host vehicle, and the processor 170 may digitize the degree of risk of danger-factors based on the trained DNN model. Further, the processor 170 may generate signals for displaying the digitized degree of risk.

The processor 170 may receive a driver selection signal for the one or more corresponding control methods through the interface unit 180, and generate a corresponding control signal depending on the selected corresponding control method. The corresponding control signal may be a signal for controlling at least one of a steering control apparatus, a brake control apparatus and an acceleration control apparatus. Driver selection may be performed through the input unit.

If there is no driver selection signal for the one or more corresponding control methods, the processor 170 may generate a corresponding control signal depending on the safest corresponding control method learned by the DNN model.

The processor 170 may calculate a degree of risk based on the trained DNN model. When the identified danger-factor satisfies the danger determination criterion, the processor 170 may calculate a degree of risk which may be defined as a possibility of occurrence of an accident of the host vehicle, based on learned data, and express the degree of risk in %.

The processor 170 may calculate the degree of risk of the danger-factor based on the trained DNN mode through digitization, and display a color corresponding to the calculated degree of risk through the RGB LEDs installed in the vehicle. The driver may intuitively sense danger while keeping eyes forward, through the RGB LEDs.

The processor 170 may store icons depending on kinds of danger-factors through driver selection, and display the icons on the display unit. The HUD may be used as the display, and the icons may be displayed through augmented reality. Details of a dangerous situation are possible through the HUD and augmented reality.

The processor 170 may inform the driver of whether or not the host vehicle needs to be changed to a safe lane or the speed of the host vehicle is changed so as to avoid the detected danger-factor. In this case, text may be displayed through the display, or voice may be output through the speaker. That is, the processor 170 may display the corresponding control method to the driver through text or voice.

The first learning model, the second learning model and the third learning model may include a Deep Neural Network (DNN) model which may learn position and time information.

The processor 170 may identify a danger-factor, determine a degree of risk of the danger-factor based on the danger determination criterion and provide a safe corresponding control method according to each situation using the first, second and third learning models, and the learning models may be Deep Neural Network (DNN) models which are trained using a machine learning algorithm or a deep learning algorithm.

The learning model may be trained by a learning process of an artificial intelligence apparatus, or be trained by a learning processor of an artificial intelligence server.

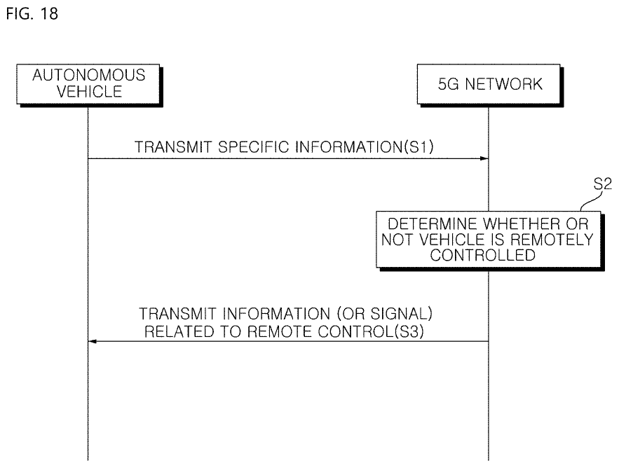

The processor 170 may identify danger-factors directly using learning models stored in the memory 140, transmit sensor information to the artificial intelligence server, and receive generated corresponding control information using learning models in the artificial intelligence server. In this case, 5G communication may be used. A basic operation method of the autonomous vehicle 10 and a 5G network will be described below with reference to FIGS. 18 to 23.

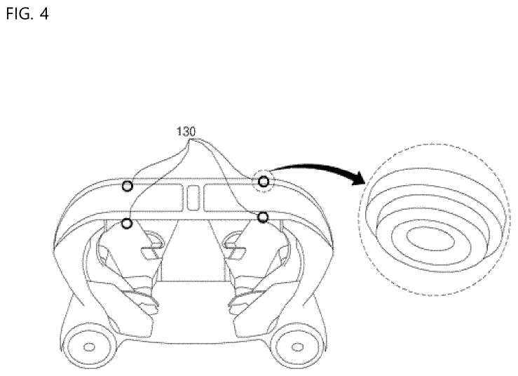

FIG. 4 is a view illustrating the cameras mounted in the vehicle in accordance with one embodiment of the present disclosure.

Referring to FIG. 4, the camera 130 may be located at a proper position of the vehicle so as to acquire an image outside the vehicle. The camera may be a mono camera, a stereo camera, an Around View Monitoring (AVM) camera or a 360-degree camera.

For example, the camera 130 may be disposed close to a front windshield in the interior of the vehicle, so as to acquire an image in front of the vehicle. Otherwise, the camera 130 may be disposed around a front bumper or a radiator grill.

For example, the camera 130 may be disposed close to a rear glass in the interior of the vehicle, so as to acquire an image at the rear of the vehicle. Otherwise, the camera 130 may be disposed around a rear bumper, a trunk or a tail gate.

For example, the camera 130 may be disposed close to at least one of side windows in the interior of the vehicle, so as to acquire an image at the side of the vehicle. Otherwise, the camera 130 may be disposed around a side mirror, a fender or a door.

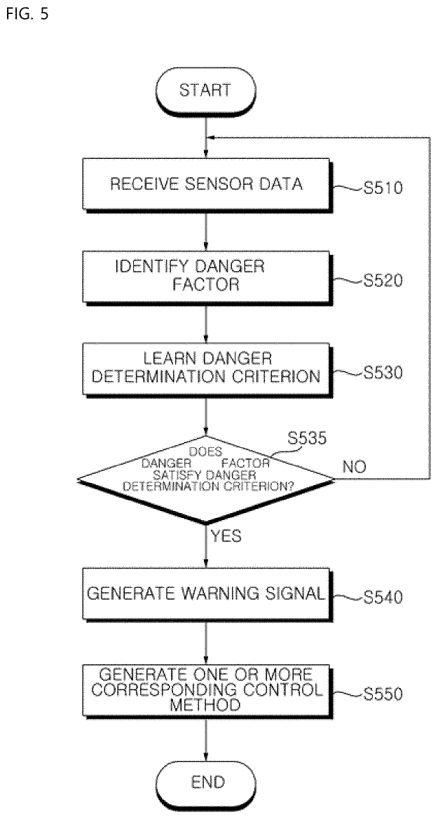

FIG. 5 is a flowchart of the processor in accordance with one embodiment of the present disclosure.

Referring to FIG. 5, the processor 170 may be operated by receiving sensor data (operation S510), identifying a danger-factor based on the sensor data (operation S520), learning a danger determination criterion of each danger-factor (operation S530), determining whether or not the danger-factor satisfies the danger determination criterion (operation S535), generating a warning signal (operation S540), and generating one or more corresponding control methods (operation S550).

In the receipt of the sensor data (operation S510), the sensor data sensed by the sensing unit 270 may be received through the interface unit 180. The sensor data may include front object information including front vehicles, rear object information including rear vehicles and peripheral object information, acquired through the radar device or the camera.

In the identification of the danger-factor (operation S520), one or more danger-factors may be detected or identified from the unprocessed sensor data. For example, the processor 170 may identify a vehicle, which changes lanes without operating turn signal lamps, a vehicle, which drives without keeping its lane, a damaged road surface, kinds of lanes, a truck, a decelerating vehicle, etc. In this case, the first learning model may be used.

Danger-factors may be various objects relating to driving of the vehicle 10. For example, the danger-factors may include vehicles and pedestrians around a host vehicle, a vehicle, which changes lanes without operating turn signal lamps, a vehicle, which drives without keeping its lane, a damaged road surface, an overloaded vehicle, a speeding vehicle, a vehicle having a brake defect, a recklessly driven vehicle, a congested road section, etc.

In the learning of the danger determination criteria (operation S530), the danger determination criterion according to the kind of the identified danger-factor in which the driver is in a dangerous situation may be learned. The danger determination criterion according to the kind of the identified danger-factor may be learned through the second learning model and stored in the memory 140.

The first learning model and the second learning model may be DNN models.

A Deep Neural Network (DNN) means an Artificial Neural Network (ANN) including multiple hidden layers between an input layer and an output layer.

In the DNN including the hidden layers, various nonlinear relations may be learned. As techniques, such as drop-out, a Rectified Linear Unit (ReLU), batch normalization, etc., are applied to the DNN, the DNN may be used as a core model in deep learning.

DNNs may include a Deep Belief Network (DBN) based on unsupervised learning according to an algorithm, a Convolution Neural Network (CNN) to process 2D data, such as an image, using deep autoencoders, a Recurrent Neural Network (RNN) to process time series data, etc.

In the determination as to whether or not the danger-factor satisfies the danger determination criterion (operation S535), it may be determined whether or not the danger-factor identified through the first learning model satisfies the danger determination criterion learned through the second learning model. When the danger-factor satisfies the danger determination criterion, the generation of the warning signal (operation S540) is performed, and when the danger-factor does not satisfy the danger determination criterion, the receipt of the sensor data (operation S510) is performed.

In the generation of the warning signal (operation S540), the warning signal for indicating presence of the danger-factor may be provided to a user. The warning signal may be a signal for displaying the kind, position and degree of risk of the danger-factor through the output unit.

The position of the danger-factor may be indicated through a signal for displaying the position of a lane in which the danger-factor is present. The processor 170 may display the position of the danger-factor by storing difference colors for respective lanes and displaying the color of the lane in which the danger-factor is present through the output unit.

The output unit may include the display unit and the acoustic output unit. The processor 170 may transmit an output signal to the output unit through the interface unit 180. The output signal may include the warning signal and a signal for displaying the corresponding control method.

A signal for displaying a degree of risk may include a signal for displaying a color corresponding to the degree of risk through the RGB LEDs installed in the vehicle, and the processor 170 may select and store the color corresponding to the degree of risk due to a user input signal.

For example, red may be stored when the degree of risk is high, yellow may be stored when the degree of risk is medium, and green may be stored when the degree of risk is low. The warning signal may be a signal which displays the digitized degree of risk together with the danger-factor, or a signal which displays the stored color of the degree of risk so as to overlap a lane.

The signal for displaying the kind of the danger-factor may include a signal which displays an icon corresponding to the kind of the danger-factor on the head up display (HUD) using augmented reality, and the processor 170 may select and store the icon corresponding to the kind of the danger-factor due to a user input signal.

In the generation of the one or more corresponding control methods (operation S550), a method for safely driving the vehicle while avoiding the danger-factor satisfying the learned danger determination criterion may be generated. Here, one or more corresponding control methods may be generated, and one corresponding control method may be selected by a user input signal or the safest corresponding control method may be selected through the third learning model.

For example, if a front overloaded vehicle is found, a first corresponding control method may be lane change to a safe lane, a second corresponding control method may be overtaking of the overloaded vehicle, and a third corresponding control method may be stoppage on a shoulder. The safest corresponding control method through the third learning model may be the first corresponding control method, i.e., lane change to a safe lane.

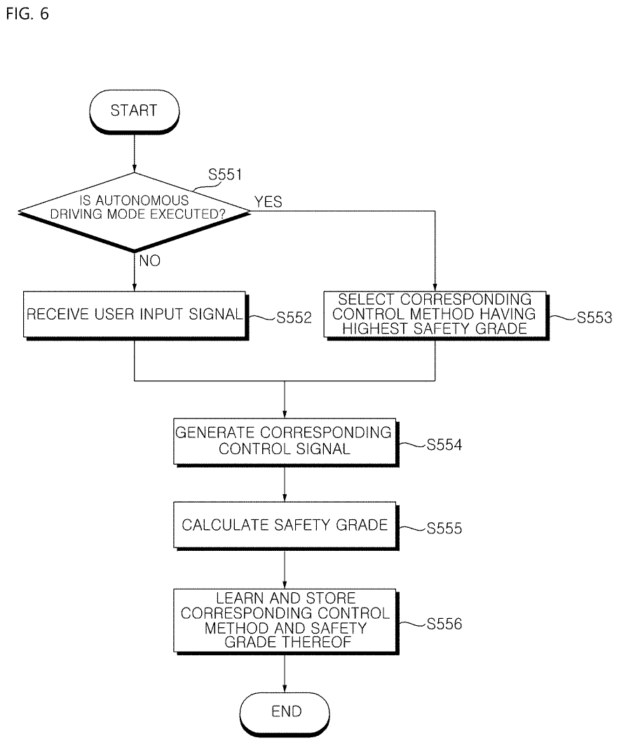

FIG. 6 is a flowchart representing determination of a danger-factor in in accordance with one embodiment of the present disclosure.

Referring to FIG. 6, the operation method of the electronic apparatus 100 may further include determining whether or not the autonomous driving mode is executed (operation S551), receiving a user input signal for selecting one corresponding control method from the one or more corresponding control methods upon determining that the autonomous driving mode is not executed (operation S552), selecting a corresponding control method having the highest safety grade from the one or more corresponding control methods upon determining that the autonomous driving mode is executed (operation S553), generating a corresponding control signal (operation S554), calculating a safety grade (operation S555), and learning and storing the corresponding control method and the safety grade (operation S556).

The processor 170 may generate one or more corresponding control methods depending on the danger-factor through the third learning model, and determine whether or not the autonomous driving mode is executed. Upon determining that the autonomous driving mode is not executed, the processor 170 may receive the user input signal, and learn a corresponding control method depending on the user input signal among the one or more corresponding control methods.

In the generation of the corresponding control signal (operation S554), when one corresponding control method is selected from the one or more corresponding control methods, a corresponding control signal depending on the selected corresponding control method may be generated. The corresponding control signal may be a signal which controls at least one of the steering control apparatus, the brake control apparatus and the acceleration control apparatus.

In the calculation of the safety grade (operation S555), when the corresponding control signal depending on the selected corresponding control method may be generated and the position, speed or status of the vehicle is changed, the safety grade may be calculated based on the position information, speed information and status information of the vehicle which are changed due to the corresponding control method.

The status information of the vehicle may include a degree of damage to the vehicle, if an accident occurs as a result of control according to the corresponding control method.

The learning and storage of the corresponding control method and the safety grade (operation S556) may include learning and storing a corresponding control method according to user preference by learning a corresponding control method depending on the user input signal among the one or more corresponding control methods. Further, the learning and storage of the corresponding control method and the safety grade (operation S556) may include learning and storing a safety grade depending on the corresponding control method.

The safety grade may be used in the selection of the corresponding control method in the autonomous driving mode (operation S553).

In the learning and storage of the corresponding control method and the safety grade (operation S556), the corresponding control method according to the user preference and the safety grade depending on the corresponding control method may be learned through the third learning model. The third learning model may include a DNN learning model.

In the selection of the corresponding control method having the highest safety grade (operation S553), the processor S170 may select the corresponding control method having the highest safety grade through the third learning model in the autonomous driving mode. When the corresponding control method depending on the safety grade is selected, the electronic apparatus 100 may be operated through the generation of the corresponding control signal (operation S554), the calculation of the safety grade (operation S555) and the learning and storing the corresponding control method and the safety grade (operation S556), as described above.

The calculation of the safety grade (operation S555) after the generation of the corresponding control signal depending on the corresponding control method having the highest safety grade may include updating the existing safety grade.

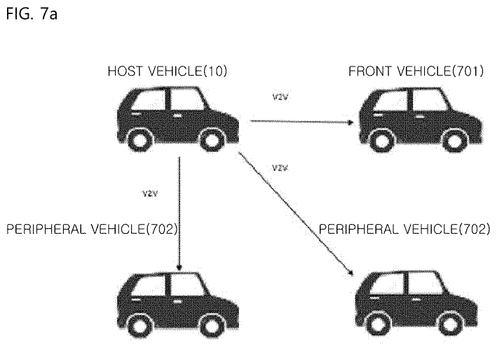

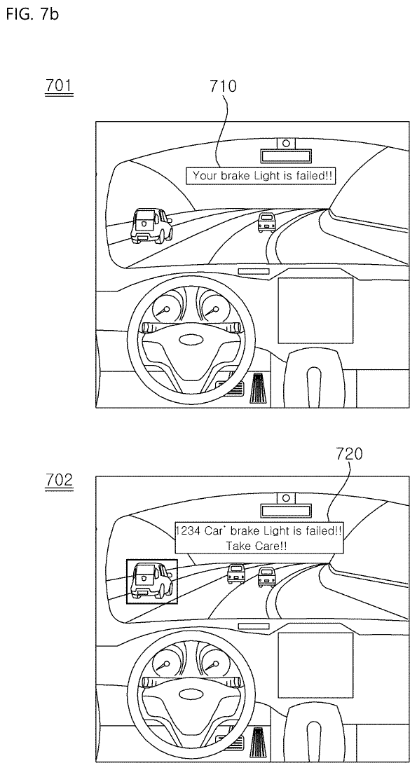

FIGS. 7A and 7B are views illustrating transmission of signals through V2V communication in accordance with one embodiment of the present disclosure.

Referring to FIG. 7A, the host vehicle may transmit signals regarding a danger-factor to one or more peripheral vehicles 702 including a front vehicle 701 through communication. In this case, V2V communication may be used. The signal regarding the danger-factor may include the kind, position, degree of risk, and corresponding control method of the danger-factor. The signals transmitted to the front vehicle 701 and the peripheral vehicles 702 may be varied according to the kind of the danger-factor. The signals may be displayed as a message.

Referring to FIG. 7B, it may be confirmed that different signals are transmitted to the front vehicle 701 and the peripheral vehicle 702. For example, if a brake light of the front vehicle 701 fails and thus is not operated even when a brake pedal of the front vehicle 701 is pressed, the danger-factor may be failure of the brake light, and thus, a message “Your brake light is failed” 710 may be transmitted to the front vehicle 701, and a message “1234 Car′ brake light is failed!! Take care!!” 720 may be transmitted to the peripheral vehicle 720.

Although not shown in the drawings, the signal regarding the danger-factor may be output to a driver as voice through the acoustic output unit.

The vehicle 10 may transmit signals regarding the danger-factor to peripheral vehicles using V2V communication so as to secure safety of drivers of the peripheral vehicles, and transmit different signals to the respective vehicles so as to enable the respective vehicles to effectively deal with a situation.

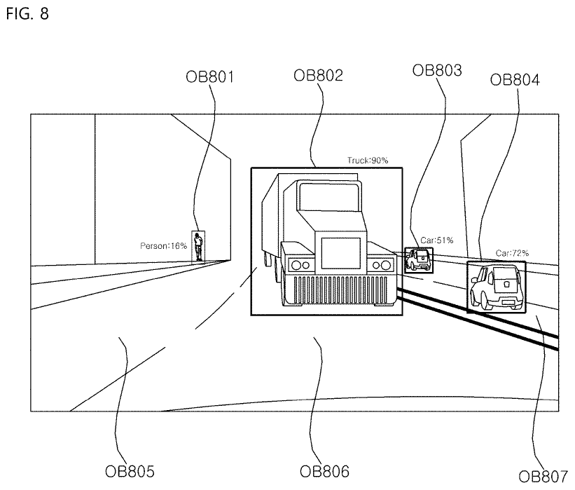

FIG. 8 is a view illustrating kinds of danger-factors, kinds of lanes in which the danger-factors are present, and the degree of risk of the danger-factors in accordance with one embodiment of the present disclosure.

Referring to FIG. 8, the processor 170 may identify kinds of objects and kinds of lanes from a rear image of the vehicle acquired through a rear camera. The identification of the kinds of the objects may include not only identification of pedestrians or vehicles but also identification of kinds of vehicles, such as cars or trucks.

The identification of the danger-factors may be executed based on the first learning model. In FIG. 8, the danger-factors may be movable objects around the vehicle. The processor 170 may regard the kinds of the objects and the kinds of the lanes as parameters, and learn the degree of risk of the parameters through the second learning model.

For example, a degree of risk of a truck may be higher than a degree of risk of a car. For example, a degree of risk of an object which is present in the same lane as the host vehicle may be higher than a degree of risk of an object which is present in the next lane.

The degree of risk may be defined as a possibility of occurrence of an accident of the host vehicle due to the identified danger-factor, and be digitized to be expressed as %. The degree of risk of the danger-factor may be calculated based on the kind, speed and position of the danger-factor, the distance of the danger-factor from the host vehicle, weather, a road state, etc. The processor 170 may digitize the degree of risk of the danger-factor and display the digitized degree of risk to the driver through the interface unit 180.

Referring to FIG. 8, in a rear image of the vehicle 10, a pedestrian OB801, a truck OB802 and two cars OB803 and OB804 may be identified as danger-factors. The degree of risk of the pedestrian OB801 may be digitized and calculated as 16%, the degree of risk of the truck OB802 may be digitized and calculated as 90%, and the degree of risk of the two cars OB803 and OB804 may be digitized and calculated as 51% and 72%, respectively. Further, the kinds of the identified danger-factors and the calculated degree of risk thereof may be displayed on the display unit.

The processor 170 may store colors depending on the respective degree of risk due to user selection. For example, the processor 170 may store green when the degree of risk is low (exceeding 0% and not more than 25%), store yellow when the degree of risk is medium (exceeding 25% and not more than 75%), and store red when the degree of risk is high (exceeding 75% and not more than 100%). Further, the colors depending on the respective degree of risk may be displayed so as to overlap lanes.

A lane OB806 in which the truck OB802 having the degree of risk of 90% is present may be displayed in red, a lane OB807 in which the two cars OB803 and OB804 having the degree of risk of 51% and 72% are present may be displayed in yellow, and a lane OB805 to which the pedestrian OB801 having the degree of risk of 16% comes close may be displayed in green. Thereby, the driver may intuitively recognize which lane is dangerous.

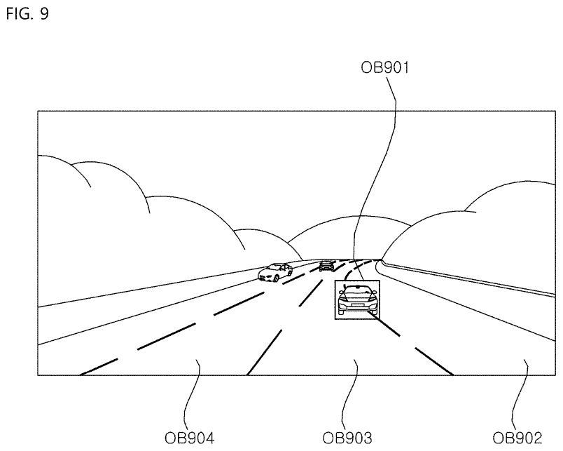

FIG. 9 is a view illustrating a rear vehicle driving without keeping its lane, which is detected from a rear image of the vehicle in accordance with one embodiment of the present disclosure.

Referring to FIG. 9, the processor 170 may identify a vehicle, which changes lanes without operating turn signal lamps, or a vehicle, which drives without keeping its lane, from a rear image of the vehicle through the first learning model.

The processor 170 may acquire a rear vehicle driver image through a high-resolution camera, and learn a status of a rear vehicle driver from the rear vehicle driver image through the second learning model. The status of the rear vehicle driver may include an eye blinking speed or a gaze direction.

The processor 170 may determine that the rear vehicle driver is in a drowsy driving state when the eye blinking speed of the rear vehicle driver is a set value or less, determine that the rear vehicle driver is in a state neglecting forward attention when the gaze direction of the rear vehicle driver is not a forward direction, and generate a warning signal for displaying the drowsy driving state or the state neglecting forward attention.

In FIG. 9, a rear vehicle OB901 driving without keeping its lane is identified from the rear image of the vehicle 10. When colors depending on respective degree of risk are stored due to user selection, a lane OB902 in which the identified rear vehicle OB901 is present and a lane OB903 which the rear vehicle OB901 invades may be displayed such that the color (for example, red) stored when the degree of risk is high overlaps the lanes OB902 and OB903. The remaining lane OB904 may be displayed such that the color (for example, green) stored when the degree of risk is low overlaps the lane OB904.

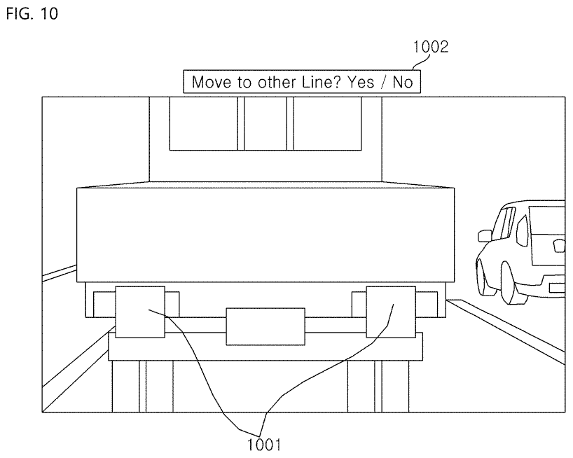

FIG. 10 is a view illustrating a vehicle having failure of brake lights, which is detected from a front image of the vehicle in accordance with one embodiment of the present disclosure.

Referring to FIG. 10, the processor 170 may identify a front vehicle which is being decelerated from a front image of the vehicle through the first learning model, and learn whether or not brake lights are operated due to deceleration of the front vehicle through the second learning model.

In more detail, a state of the front vehicle may be analyzed through the radar device or an ADAS camera of the vehicle, and information, such as a distance between vehicles, vehicle speeds, etc., may be extracted through objects identified from image information acquired by the camera. In this case, a trained DNN model which may detect information, such as whether or not a brake pedal of the front vehicle is pressed or a deceleration of the front vehicle, may be stored in advance.

Further, whether or not the brake pedal of the front vehicle is pressed may be determined and whether or not brake lights of the front vehicle are normally operated may be detected by inputting information acquired through the sensor, such as the camera or the radar device, to the trained DNN model. If the brake lights of the front vehicle are not operated even upon determining that the brake pedal of the front vehicle is pressed, it may be determined that the brake lights corresponding to one danger-factor are defective.

When the identified front vehicle is determined as a danger-factor, i.e., a vehicle having failure of brake lights, based on the danger determination criterion, if the processor 170 determines that the front vehicle is being decelerated through the sensor, the processor 170 may display the brake lights 1001 of the front vehicle as being turned on through the HUD using augmented reality. Simultaneously, for the purpose of safe driving, a message 1002 asking whether or not the vehicle is moved to a different lane from the lane in which the front vehicle having failure of the brake lights is present may be output as text or voice.

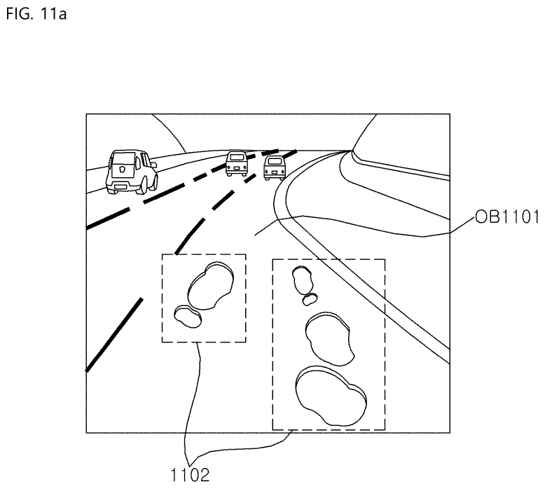

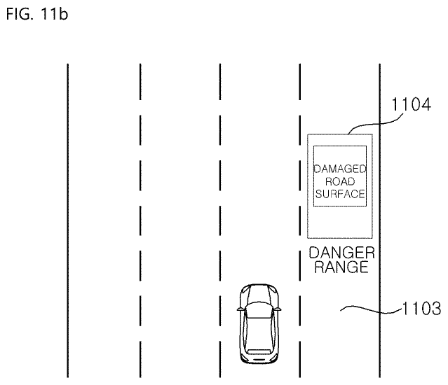

FIGS. 11A and 11B are views illustrating a damaged road surface, which is detected from a front image of the vehicle in accordance with one embodiment of the present disclosure.

Referring to FIGS. 11A and 11B, the processor 170 may identify a front road as an object through a front camera, and identify a damaged road surface and a kind of a lane from a front image of the vehicle through the first learning model.

The processor 170 may learn a degree of shaking of the vehicle and a damaged state of a front road surface during driving on a road through the second learning model.

The processor 170 may store the front image of the vehicle together with position information when the degree of shaking of the vehicle is a set value or more, generate a first warning signal when the vehicle enters the position information within a predetermined distance, and generate a second warning signal when the damaged road surface is identified from the front image of the vehicle.

In more detail, the processor 170 may continuously learn the surface state of a road during driving on the road, and determine the immediately preceding surface state of the road as a damaged road surface and store the damaged road surface together with GPS information when the degree of shaking of the vehicle is a designated level or more. Image data of the damaged road surface may be repeatedly learned through continuous driving.

Further, the surface state of the road may be checked by the front camera of the vehicle, and thus, a normal road surface state and a damaged road surface state may be distinguished through the DNN learning model. For example, when a normal road state, such as a speed bump, is detected even if shaking of the vehicle occurs during driving, this state may be distinguished from the damaged road surface based on the acquired camera image and the DNN learning model.

When the identified front road surface is determined as a danger-factor, such as a damaged road surface, based on the danger determination criterion, the processor 170 may output a voice warning or display the damaged road surface and a danger range 1104 on the display through augmented reality, when the vehicle gets close to a road 1103 in which the damaged road surface is present, as shown in FIG. 11B. As shown in FIG. 11A, when a damaged road surface OB1101 in front of the vehicle is detected by the front camera, corresponding regions 1102 may be displayed through the display.

Further, when the vehicle enters the road in which the damaged road surface is present under the condition that snow and rain is recognized through a rain sensor, a warning may be output as voice or through the display.

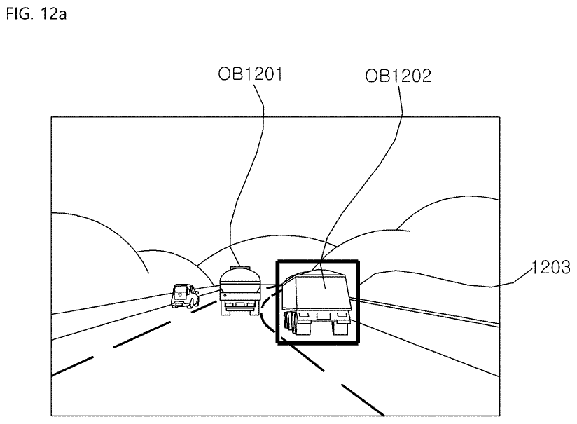

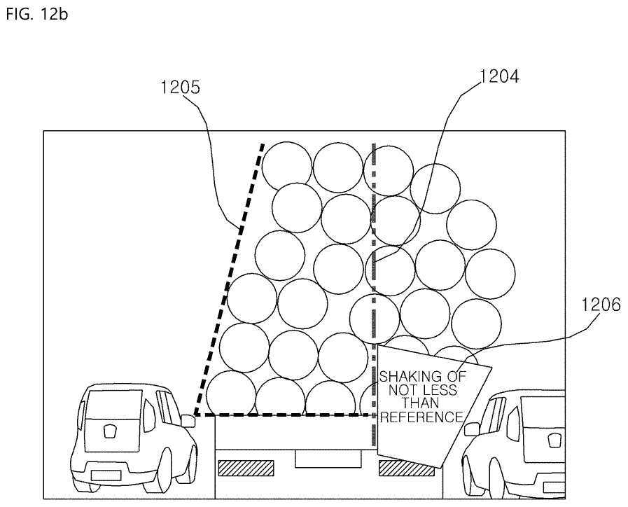

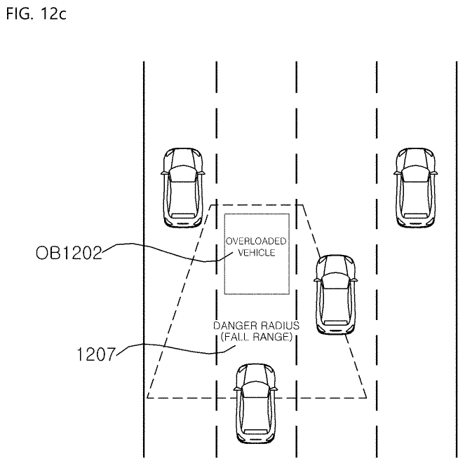

FIGS. 12A to 12C are views illustrating an overloaded vehicle, which is detected from a front image of the vehicle in accordance with one embodiment of the present disclosure.

Referring to FIGS. 12A to 12C, the processor 170 may identify a front vehicle as an object through the front camera, and determination as to whether or not the identified front vehicle is a danger-factor may be based on a danger determination criterion including a kind, speed and position of a movable object, and a distance of the movable object from the host vehicle.

The processor 170 may identify at least one of a kind of a truck or a degree of symmetry of cargo loaded on the truck from a front image of the vehicle though the first learning model, and learn height information due to the kind of the truck or a degree of shaking of the truck due to the degree of symmetry of the cargo loaded on the truck through the second learning model.

In more detail, the processor 170 may continuously collect data of trucks depending on the surface state and kind of a road during driving on the road, and learn and store heights depending on kinds of trucks based on the DNN model, thus being capable of extracting ideal heights of the trucks which do not disrupt driving of the vehicle.

Further, the processor 170 may continuously learn a degree of symmetry and a degree of shaking of the front truck during driving, and set a reference line and a reference angle based on the learned information. Also, the processor 170 may calculate the degree of symmetry and the degree of shaking of the front truck through a degree of symmetry of cargo loaded on the truck based on the reference line learned through the DNN model and a degree of tilt of the cargo loaded on the truck based on the reference angle learned through the DNN model.

When the degree of shaking of the vehicle during driving is a designated degree or more, the immediately preceding surface state of the road may be determined as a damaged road surface and the damaged road surface together with GPS information thereof may be stored. Image data of the damaged road surface may be repeatedly learned through continuous driving.

When the identified truck is determined as an overloaded vehicle corresponding to a danger-factor based on the danger determination criteria acquired by learning heights, kinds, speeds, degrees of symmetry and degrees of shaking of vehicles, kinds of roads and road surfaces, the processor 170 may generate a signal for displaying a position of the overloaded vehicle and a predicted fall range of cargo from the overloaded vehicle.

For example, when among identified front trucks OB1201 and OB1202, the overloaded vehicle OB1202 is determined as a danger-factor, presence and a position 1203 of the overloaded vehicle OB1202 may be displayed, as shown in FIG. 12A. Referring to FIG. 12B, a learned reference line 1204 and a learned reference angle 1205 may be displayed, and a degree of shaking 1206 which is not less than a reference may be sensed.

Further, as shown in FIG. 12C, a predicted fall range or danger radius 1207 of the cargo loaded on the overloaded vehicle may be displayed to the driver through augmented reality. In this case, the predicted fall range of the cargo may be acquired in consideration of the speed and degree of shaking of the overloaded vehicle and the height of the cargo.

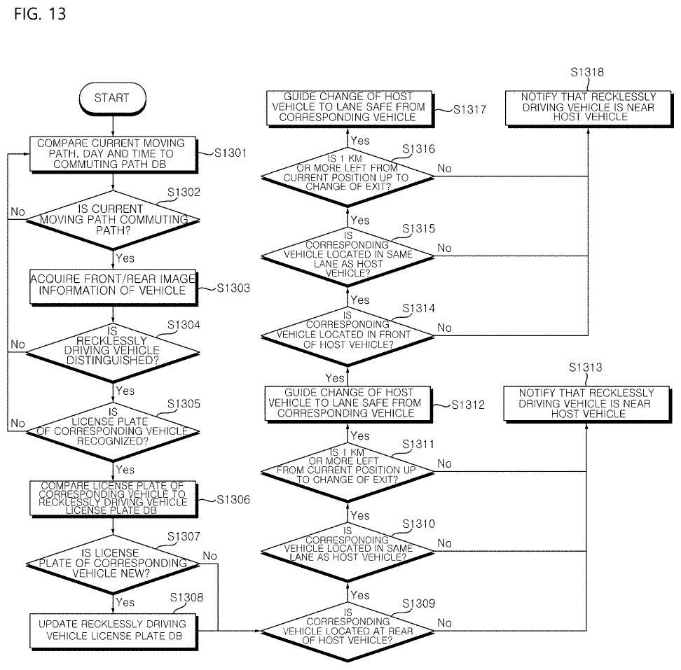

FIG. 13 is a flowchart illustrating search and guidance of a recklessly driving vehicle.

Referring to FIG. 13, the electronic apparatus 100 may safely guide the driver to a destination while avoiding a recklessly driving vehicle on a commuting path using commuting path data, recklessly driving vehicle data, real-time image information of the front and rear cameras of the host vehicle, a navigation moving path, and the trained DNN model.

The processor 170 may identify at least one vehicle of a vehicle which changes lanes without operating turn signal lamps, a vehicle which operates a turn signal, a vehicle which operates an emergency brake, a vehicle which drives beyond a reference speed, or a vehicle which does not assure a safe distance through the first learning model, learn a driving pattern of the identified vehicle through the second learning model, and, when the identified vehicle is determined as a recklessly driving vehicle, generate a warning signal for displaying presence and a position of the recklessly driving vehicle.

In more detail, a current moving path, day and time may be compared to commuting path data (operation S1301), and whether or not the current moving path is the commuting path may be determined (operation S1302). Upon determining that the current moving path is the commuting path, front and rear image information of the host vehicle may be acquired (operation S1303), a recklessly driving vehicle may be distinguished (operation S1304), and the license plate of the corresponding vehicle may be recognized (operation S1305).

The distinguishment of the recklessly driving vehicle (operation S1304) may be determined through the DNN model trained based on the danger determination criterion including whether or not the vehicle frequently changes lanes, whether or not the vehicle operates emergency brakes, whether or not the vehicle exceeds the speed limit of a road, and whether or not the vehicle assures a safe distance. The recognition of the license plate of the corresponding vehicle (operation S1305) may also be performed through the DNN model.

The license plate of the corresponding driving vehicle may be compared to recklessly driving vehicle license plate data (operation S1306), and thus, whether or not the license plate of the corresponding driving vehicle is new may be determined (operation S1307). Upon determining that the license plate of the corresponding driving vehicle is new, the recklessly driving vehicle license plate data may be updated (operation S1308), and whether or not the corresponding vehicle is located at the rear of the host vehicle and whether or not the corresponding vehicle is located in the same lane as the host vehicle may be determined through the trained DNN model (operations S1309 and S1310).

Upon determining that the corresponding vehicle is located at the rear of the host vehicle in the same lane, whether or not 1 km or more is left from a current position up to change of an exit may be determined (operation S1311), and, upon determining that 1 km or more is left from the current position up to change of the exit, lane change of the host vehicle to a lane which is safe from the corresponding vehicle may be guided (operation S1312). Upon determining that 1 km or more is not left from the current position up to change of the exit, it may be notified that the recklessly driving vehicle is near the host vehicle (operation S1313), and whether or not the corresponding vehicle is located in front of the host vehicle and whether or not the corresponding vehicle is located in the same lane as the host vehicle may be determined through the trained DNN model (operations S1314 and S1315).

Upon determining that the corresponding vehicle is located in front of the host vehicle in the same lane, whether or not 1 km or more is left from a current position up to change of an exit may be determined (operation S1316), and, upon determining that 1 km or more is left from the current position up to change of the exit, lane change of the host vehicle to a lane which is safe from the corresponding vehicle may be guided (operation S1317). Upon determining that 1 km or more is not left from the current position up to change of the exit, it may be notified that the recklessly driving vehicle is near the host vehicle (operation S1318).

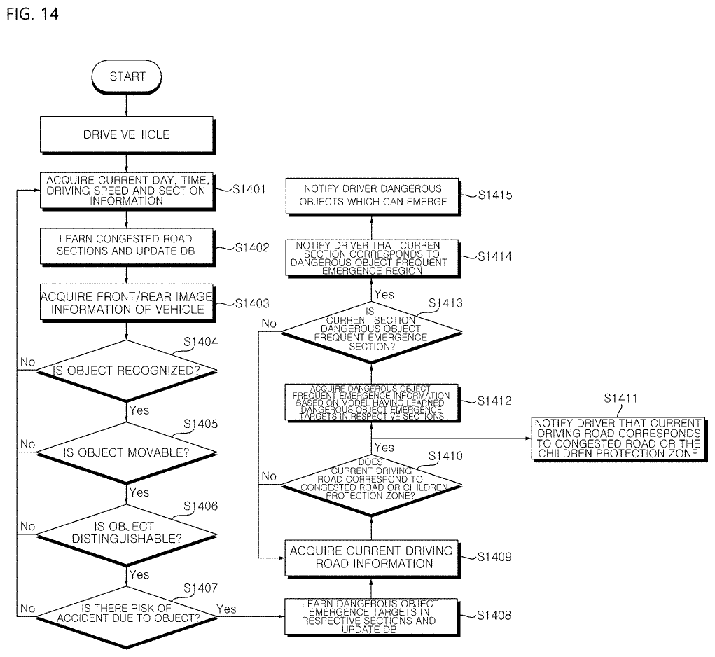

FIG. 14 is a flowchart illustrating search and guidance of a congested road section.

Referring to FIG. 14, the electronic apparatus 100 may learn a road situation and dangerous object emergence situations in respective sections through driving day and time, driving speed information and front and rear image information, recognize in advance a congested road or a children protection zone based on the trained DNN model, and provide in advance information about a dangerous object frequent emergence section to the driver.

The processor 170 may identify a movable object through the first learning model, learn an emergence frequency of the movable object depending on time and section information through the second learning model, and generate a warning signal for displaying the time and section information and the movable object which can emerge, when the emergence frequency of the movable object is a set value or more.

In more detail, when driving of the host vehicle is started, current day and time, driving speed information and section information may be acquired (operation S1401), and a congestion section of the road may be learned and the DNN model may be stored and updated based on these pieces of information (operation S1402). Thereafter, the front and rear image information of the host vehicle may be acquired (operation S1403), whether or not an object is recognized (operation s1404), whether or not the object is movable (operation S1405), whether or not the object is distinguishable (operation S1406), and whether or not there is a risk of an accident due to the object (operation S1407) may be determined based on the trained DNN model.

As a result, when the object is determined as a dangerous object, dangerous object emergence targets in respective sections may be learned and the model may be stored and updated (operation S1408). Current driving road information may be acquired based on the trained DNN model (operation S1409), whether or not the current driving road corresponds to a congested road or a children protection zone may be determined (operation S1410), the driver may be notified that the current driving road corresponds to the congested road or the children protection zone (operation S1411).

Further, dangerous object frequent emergence information may be acquired based on the DNN model having learned the dangerous object emergence targets in the respective sections (operation S1412), whether or not a section in which the host vehicle drives currently is a dangerous object frequent emergence section may be determined (operation S1413), the driver may be notified that the current section corresponds to a dangerous object frequent emergence region (operation S1414), and dangerous objects which can emerge may be notified (operation S1415).

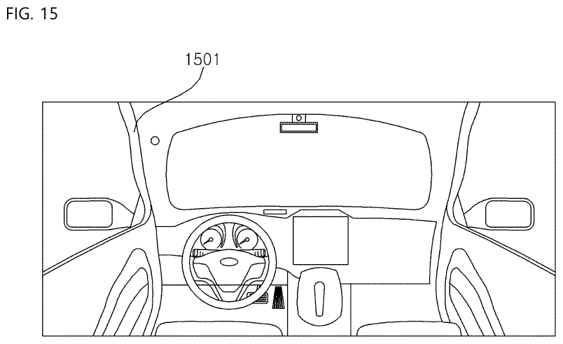

FIG. 15 is a view illustrating notification through the RGB LEDs.

Referring to FIG. 15, the electronic apparatus 100 may store colors depending on respective degree of risk due to driver selection. For example, a high degree of risk may be stored as red, a medium degree of risk may be stored as yellow, and a low degree of risk may be stored as green. The processor 170 may digitize the degree of risk based on the trained DNN model.

The degree of risk may be defined as a possibility of occurrence of an accident of the host vehicle due to an identified object. The degree of risk may be calculated through the DNN model trained based on kinds, speeds and positions of objects, distances of the objects from the host vehicle, weather, road states, etc. The processor 170 may digitize degree of risk of the objects and display the digitized degree of risk to the driver through the interface unit 180.

The processor 170 may calculate a degree of risk of a danger-factor based on the trained DNN model, and display a color corresponding to the calculated degree of risk of the danger-factor through RGB LEDs 1501 installed in the vehicle. For example, red light may be displayed when the degree of risk is high, yellow light may be displayed when the degree of risk is medium, and green light may be displayed when the degree of risk is low.

Through the RGB LEDs, the driver may intuitively sense danger even while keeping eyes forward.

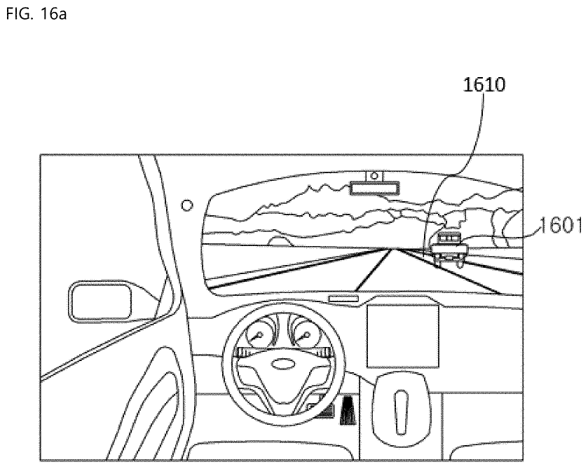

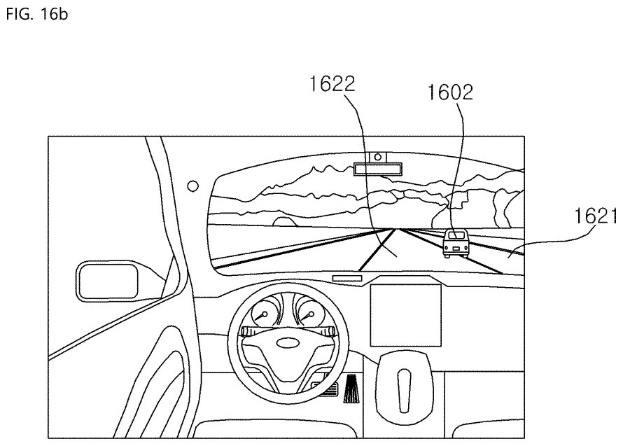

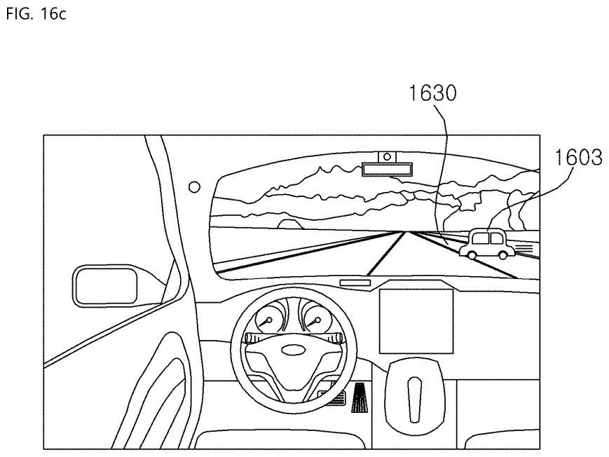

FIGS. 16A to 16C are views illustrating display of icons depending on kinds of danger-factors using augmented reality.

Referring to FIGS. 16A to 16C, the electronic apparatus 100 may select and store an icon depending on the kind of a danger-factor by a user input signal, and display the icon through the display unit. The processor 170 may generate a signal for displaying the kind of the danger-factor through the icon.

The display may include the HUD, and the icon may be displayed through augmented reality. Detailed guidance for a dangerous situation through the HUD and augmented reality is possible.

In FIG. 16A, a first icon 1601 indicating a large vehicle, for example, a truck, identified from a front image of the vehicle, i.e., one of danger-factors, may be displayed. The first icon 1601 depending on the large vehicle corresponding to the danger-factor may be stored due to user selection, and, when the danger-factor satisfies the danger determination criterion, the first icon 1601 may be displayed on the HUD through augmented reality. Further, a lane 1611 in which the danger-factor is located may be displayed in red indicating a high degree of risk.

In FIG. 16B, a second icon 1602 indicating a vehicle which cannot keep its lane, identified from a front image of the vehicle, i.e., one of danger-factors, may be displayed. The second icon 1602 depending on the vehicle which cannot keep its lane may be stored due to user selection, and, when the danger-factor satisfies the danger determination criterion, the second icon 1602 may be displayed on the HUD through augmented reality. Further, a lane 1621 in which the danger-factor is located and a lane 1622 next to the lane 1621 may be displayed in red indicating a high degree of risk.

In FIG. 16C, a third icon 1603 indicating a speeding vehicle, identified from a rear image of the vehicle, i.e., one of danger-factors, may be displayed. The third icon 1603 depending on the speeding vehicle may be stored due to user selection, and, when the danger-factor satisfies the danger determination criterion, the third icon 1603 may be displayed on the HUD through augmented reality. Further, a lane 1630 in which the danger-factor is located may be displayed in red indicating a high degree of risk.

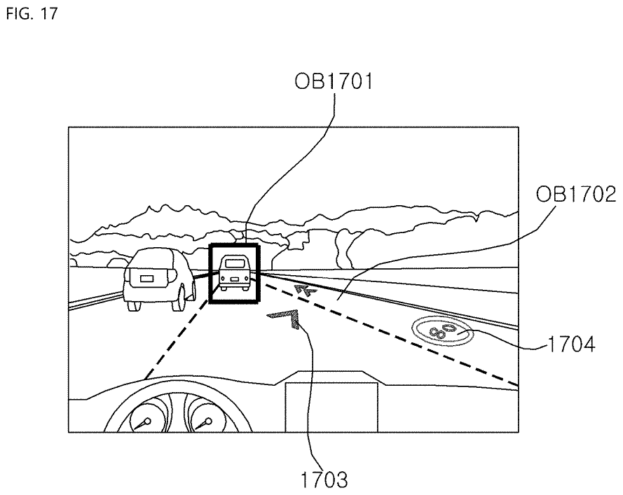

FIG. 17 is a view illustrating guidance of the vehicle to a safe lane to avoid a danger-factor.

Referring to FIG. 17, the electronic apparatus 100 may inform the driver of whether or not the vehicle is moved to a safe lane to avoid a danger-factor or whether or not the speed of the vehicle is changed. In this case, text may be displayed through the display or voice may be output through the speaker. That is, the processor 170 may generate a signal for displaying a corresponding control method to the driver through text or voice.

When a front vehicle OB1701 in a front image of the host vehicle satisfies the danger determination criterion, the electronic apparatus 100 may display a corresponding method 1703 which moves the host vehicle to a next safe line OB1702 to avoid the front vehicle OB1701, through augmented reality. Further, a speed limit 1704 of a corresponding section may also be displayed so that the driver safely changes lanes while observing the speed limit.

Here, one or more corresponding control methods may be provided. The processor 170 may determine one of the one or more corresponding control methods due to a user input signal, and determine one safest corresponding control method out of the one or more corresponding control methods through the trained DNN model.

When one corresponding control method is determined due to the user input signal, the processor 170 may generate a corresponding control signal for controlling at least one of the steering control apparatus, the brake control apparatus or the acceleration control apparatus depending on the determined corresponding control method.

For example, the electronic apparatus 100 may cause the host vehicle to change lanes through a signal for controlling the steering control apparatus when a first corresponding control method for changing lanes is determined, to overtake a front vehicle through a signal for controlling the steering control apparatus and the acceleration control apparatus when a second corresponding control method for overtaking the front vehicle is determined, and to stop on a shoulder through a signal for controlling the steering control apparatus and the brake control apparatus when a third corresponding control method for stopping on the shoulder is determined.

FIG. 18 is a view illustrating one example of basic operations of the autonomous vehicle and a 5G network in a 5G communication system.

The autonomous vehicle 10 transmits specific information to the 5G network (operation S1). The specific information may include information related to autonomous driving. The information related to autonomous driving may be information directly related to driving control of the vehicle 10.

For example, the information related to autonomous driving may include one or more of object data indicating objects around the vehicle, map data, vehicle status data, vehicle position data and driving plan data.

The information related to autonomous driving may further include service information necessary for autonomous driving. For example, the service information may include information regarding a destination input through a user terminal and information regarding a safety class of the vehicle 10. Further, the 5G network may determine whether or not the vehicle 10 is remotely controlled (operation S2).

Here, the 5G network may include a server or a module which performs remote control related to autonomous driving.

The 5G network may transmit information (or a signal) related to remote control to the autonomous vehicle 10 (operation S3).

As described above, the information related to remote control may be a signal which is directly applied to the autonomous vehicle 10, and further include service information necessary for autonomous driving. In accordance with one embodiment of the present disclosure, the autonomous vehicle 10 may provide service related to autonomous driving by receiving service information, such as insurance in each section and dangerous section information selected from the driving path, through a server connected to the 5G network.

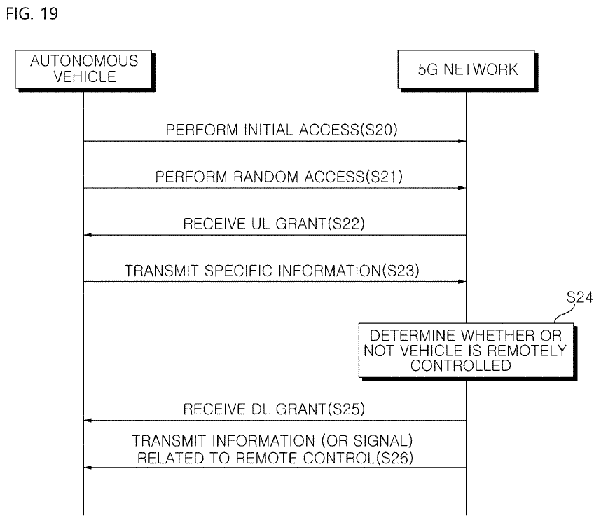

Hereinafter, FIGS. 19 to 23 schematically illustrate an essential process for 5G communication between the autonomous vehicle 10 and the 5G network (for example, an initial access procedure between the vehicle and the 5G network, etc.), so as to provide insurance service applicable to each section during an autonomous driving process in accordance with one embodiment of the present disclosure.

FIG. 19 is a view illustrating one example of application operations of the autonomous vehicle 10 and the 5G network in the 5G communication system.

The autonomous vehicle 10 performs the initial access procedure with the 5G network (operation S20).

The initial access procedure includes a cell search process for acquiring downlink (DL) operation, and a system information acquisition process, etc.

The autonomous vehicle 10 performs a random access procedure with the 5G network (operation S21).

The random access procedure may include a preamble transmission process for acquiring uplink (UL) synchronization or transmitting UL data, a random access response reception process, etc.

Thereafter, the 5G network may transmit a UL grant for scheduling transmission of specific information to the autonomous vehicle 10 (operation S22).

Reception of the UL grant may include a process of receiving time/frequency resource scheduling for transmitting UL data to the 5G network.

Thereafter, the autonomous vehicle 10 transmits the specific information to the 5G network based on the UL grant (operation S23).

Thereafter, the 5G network determines whether or not the vehicle 10 is remotely controlled (operation S24).

Thereafter, the autonomous vehicle 10 receives a DL grant through a physical downlink control channel for receiving a response to the specific information from the 5G network (operation S25).

Then, the 5G network transmits information (or a signal) related to remote control to the autonomous vehicle 10 based on the DL grant (operation S26).

Although FIG. 19 exemplarily illustrates an example of a combination among an initial access process between the autonomous vehicle 10 and 5G communication, a random access process therebetween and a downlink grant reception process through operations S20 to S26, the present disclosure is not limited thereto.

For example, the initial access process and/or the random access process may be performed through operations S20, S22, S23, S24 and S26. Further, for example, the initial access process and/or the random access process may be performed through operations S21, S22, S23, S24 and S26. Also, a combination process between an AI operation and the downlink grant reception process may be performed through operations S23, S24, S25 and S26.

Further, although FIG. 19 exemplarily illustrates the operation of the autonomous vehicle 10 through operations S20 to S26, the present disclosure is not limited thereto.

For example, the operation of the autonomous vehicle 10 may be performed by selectively combining operations S20, S21, S22 and S25 with operations S23 and S26. Further, for example, the operation of the autonomous vehicle 10 may include operations S21, S22, S23 and S26. Also, for example, the operation of the autonomous vehicle 10 may include operations S20, S21, S23 and S26. Moreover, for example, the operation of the autonomous vehicle 10 may include operations S22, S23, S25 and S26.

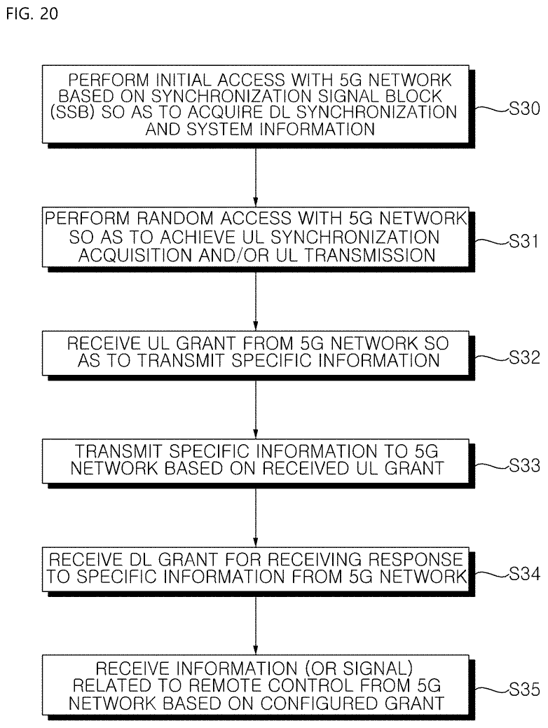

FIGS. 20 to 23 are flowcharts, each of which represents one example of the operation of the autonomous vehicle 10 using 5G communication.

First, referring to FIG. 20, the autonomous vehicle 10 including an autonomous driving module performs an initial access procedure with the 5G network based on a synchronization signal block (SSB) so as to acquire DL synchronization and system information (operation S30).

Thereafter, the autonomous vehicle 10 performs a random access procedure with the 5G network so as to achieve UL synchronization acquisition and/or UL transmission (operation S31).

Thereafter, the autonomous vehicle 10 receives a UL grant from the 5G network so as to transmit specific information (operation S32).

Thereafter, the autonomous vehicle 10 transmits the specific information to the 5G network based on the UL grant (operation S33).

Thereafter, the autonomous vehicle 10 receives a DL grant for receiving a response to the specific information from the 5G network (operation S34).

Thereafter, the autonomous vehicle 10 receives information (or a signal) related to remote control from the 5G network based on the DL grant (operation S35).

A beam management (BM) process may be added to operation S30, a beam failure recovery process related to transmission of a physical random access channel (PRACH) may be added to operation S31, a QCL relationship related to a beam receiving direction of a PDCCH including the UL grant may be added to operation S32, and a QCL relationship related to a beam transmitting direction of a physical uplink control channel (PUCCH)/a physical uplink shared channel (PUSCH) including the specific information may be added to operation S33. Further, a QCL relationship related to a beam receiving direction of a PDCCH including the DL grant may be added to operation S34.

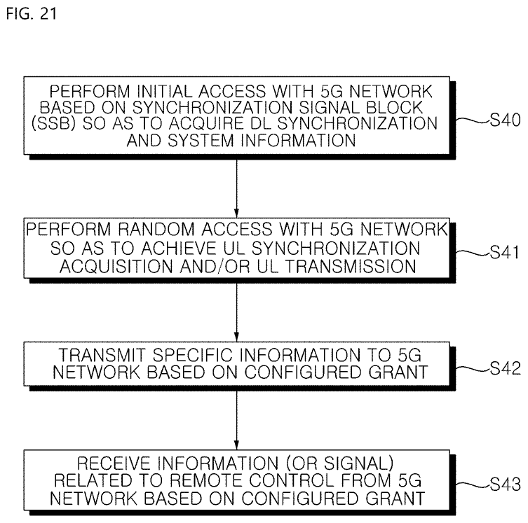

Referring to FIG. 21, the autonomous vehicle 10 performs an initial access procedure with the 5G network based on an SSB so as to acquire DL synchronization and system information (operation S40).

Thereafter, the autonomous vehicle 10 performs a random access procedure with the 5G network so as to achieve UL synchronization acquisition and/or UL transmission (operation S41).

Thereafter, the autonomous vehicle 10 transmits specific information to the 5G network based on a configured grant (operation S42). The specific information may be transmitted to the 5G network based on the configured grant, instead of a process for performing the UL grant from the 5G network.

Therefore, the autonomous vehicle 10 receives information (or a signal) related to remote control from the 5G network based on the configured grant (operation S43).

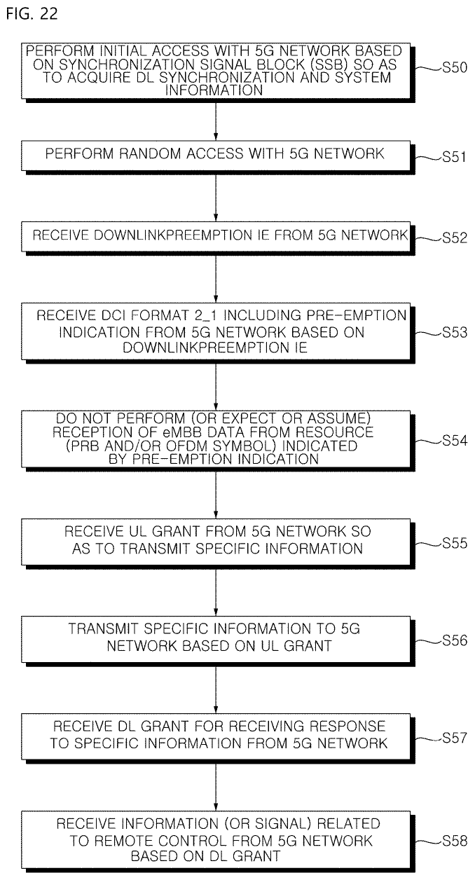

Referring to FIG. 22, the autonomous vehicle 10 performs an initial access procedure with the 5G network based on an SSB so as to acquire DL synchronization and system information (operation S50).

Thereafter, the autonomous vehicle 10 performs a random access procedure with the 5G network so as to achieve UL synchronization acquisition and/or UL transmission (operation S51).

Thereafter, the autonomous vehicle 10 receives a DownlinkPreemption IE from the 5G network (operation S52).

Thereafter, the autonomous vehicle 10 receives a DCI format 2_1 including a pre-emption indication from the 5G network based on the DownlinkPreemption IE (operation S53).

Thereafter, the autonomous vehicle 10 does not perform (or expect or assume) reception of eMBB data from a resource (a PRB and/or an OFDM symbol) indicated by the pre-emption indication (operation S54).

Thereafter, the autonomous vehicle 10 receives a UL grant from the 5G network so as to transmit specific information (operation S55).

Thereafter, the autonomous vehicle 10 transmits the specific information to the 5G network based on the UL grant (operation S56).

Thereafter, the autonomous vehicle 10 receives a DL grant for receiving a response to the specific information from the 5G network (operation S57).

Thereafter, the autonomous vehicle 10 receives information (or a signal) related to remote control from the 5G network based on the DL grant (operation S58).

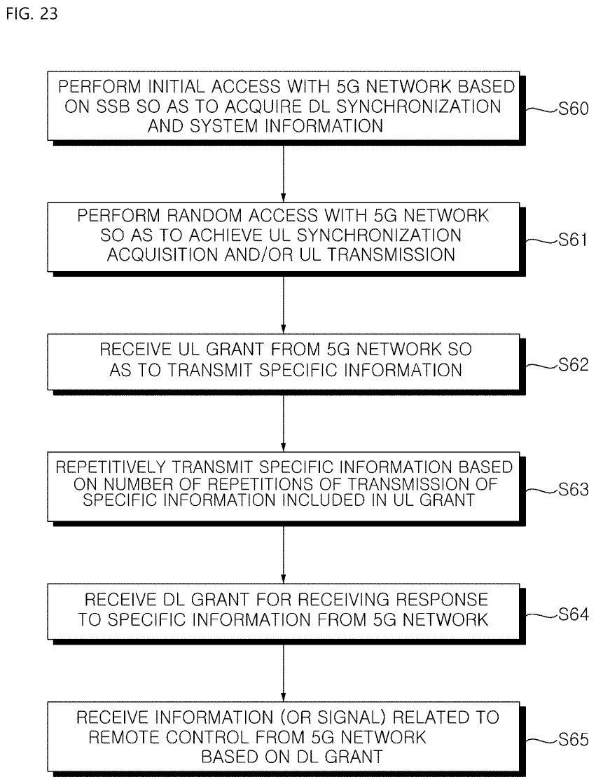

Referring to FIG. 23, the autonomous vehicle 10 performs an initial access procedure with the 5G network based on an SSB so as to acquire DL synchronization and system information (operation S60).

Thereafter, the autonomous vehicle 10 performs a random access procedure with the 5G network so as to achieve UL synchronization acquisition and/or UL transmission (operation S61).

Thereafter, the autonomous vehicle 10 receives a UL grant from the 5G network so as to transmit specific information (operation S62).

The UL grant includes information regarding the number of repetitions of the transmission of the specific information, and the specific information is repetitively transmitted based on the information regarding the number of repetitions (operation S63).

Thereafter, the autonomous vehicle 10 transmits the specific information to the 5G network based on the UL grant.

Further, the repetitive transmission of the specific information may be performed through frequency hopping, first transmission of the specific information may be performed by a first frequency resource, and second transmission of the specific information may be performed by a second frequency resource.

The specific information may be transmitted through a narrowband of a 6 Resource Block (RB) or 1 Resource Block (RB).

Thereafter, the autonomous vehicle 10 receives a DL grant for receiving a response for the specific information from the 5G network (operation S64).

Thereafter, the autonomous vehicle 10 receives information (or a signal) related to remote control from the 5G network based on the DL grant (operation S65).

The above-described 5G communication technology may be combined with the methods supposed in the description of the disclosure, as shown in FIGS. 1 to 17, or be complementarily used to materialize or disambiguate technical characteristics of the methods supposed in the description of the disclosure.

The vehicle 10 described in the present disclosure may be connected to an external server through a communication network, and be moved along a predetermined path without driver intervention using autonomous driving technology. The vehicle 10 of the present disclosure may be implemented as an internal combustion vehicle provided with an engine as a power source, a hybrid vehicle provided with both an engine and an electric motor as power sources, an electric vehicle provided with an electric motor as a power source, etc.

In the embodiments, a user may be interpreted as a driver, a passenger or an owner of a user terminal. The user terminal may be a mobile terminal which may be carried by a user and execute telephone call and various applications, for example, a smartphone, but is not limited thereto. For example, the user terminal may be interpreted as a mobile terminal, a personal computer (PC), a notebook computer, or an autonomous vehicle system.

In the autonomous vehicle 10, an accident type and a frequency of accident occurrence may be greatly varied according to ability to sense peripheral danger-factors in real time. A path to a destination may include sections having different risk levels depending on various causes, such as weather, topographical characteristics, a degree of traffic congestion, etc. In the present disclosure, when a user inputs a destination, insurance in each section is guided, and the insurance guidance is updated through monitoring of dangerous sections in real time.

One or more of the autonomous vehicle 10 in accordance with the present disclosure, the user terminal and the server may be connected to or combined/integrated with an Artificial Intelligence module, an unmanned aerial vehicle (UAV), such as a drone, a robot, an augmented reality (AR) apparatus, a virtual reality (VR) apparatus, an apparatus related to 5G service, etc.

For example, the autonomous vehicle 10 may be operated in connection with at least one artificial intelligence module included in the vehicle 10, or robot.

For example, the vehicle 10 may interact with at least one robot. The robot may be an Autonomous Mobile Robot (AMR) which may autonomously travel by its own efforts. The mobile robot is autonomously movable and may thus freely move, and is provided with a plurality of sensors to avoid obstacles during traveling and may thus travel to avoid the obstacles. The mobile robot may be a flying robot which has a flying apparatus (for example, a drone). The mobile robot may be a wheeled robot which has at least one wheel and is moved through rotation of the at least one wheel. The mobile robot may be a legged robot which has at least one leg and is moved using the at least one leg.

The robot may function as an apparatus which compensates for user convenience. For example, the robot may perform a function of moving baggage loaded in the vehicle 10 to a user's final destination. For example, the robot may perform a function of guiding a user getting out of the vehicle 10 to a final destination. For example, the robot may perform a function of transporting a user getting out of the vehicle 10 to a final destination.

At least one electronic apparatus included in the vehicle 10 may perform communication with the robot through the communication apparatus 220.

The at least one electronic apparatus included in the vehicle 10 may provide data, processed by the at least one electronic apparatus included in the vehicle, to the robot. For example, the at least one electronic apparatus included in the vehicle 10 may provide at least one of object data indicating objects around the vehicle 10, map data, status data of the vehicle 10, position data of the vehicle 10 or driving plan data.

The at least one electronic apparatus included in the vehicle 10 may receive data, processed by the robot, from the robot. The at least one electronic apparatus included in the vehicle 10 may receive at least one of sensing data, object data, robot status data, robot position data or robot moving plan data, generated by the robot.

The at least one electronic apparatus included in the vehicle 10 may generate a control signal based further on data received from the robot. For example, the at least one electronic apparatus included in the vehicle 10 may compare information about objects generated by the object detection apparatus to information about objects generated by the robot, and generate a control signal based on a result of the comparison. The at least one electronic apparatus included in the vehicle 10 may generate a control signal so as to avoid interference between a moving path of the vehicle 10 and a moving path of the robot.

The at least one electronic apparatus included in the vehicle 10 may include a software module or a hardware module which realizes artificial intelligence (AI) (hereinafter, referred to as an artificial intelligence module). The at least one electronic apparatus included in the vehicle 10 may input acquired data to the artificial intelligence module and use data output from the artificial intelligence module.

The artificial intelligence module may perform machine learning of the input data using at least one artificial neural network (ANN). The artificial intelligence module may output driving plan data through machine learning of the input data.

The at least one electronic apparatus included in the vehicle 10 may generate a control signal based on data output from the artificial intelligence module.

In accordance with embodiments, the at least one electronic apparatus included in the vehicle 10 may receive data processed by artificial intelligence, from an external apparatus through the communication apparatus 220. The at least one electronic apparatus included in the vehicle 10 may generate a control signal based on the data processed by artificial intelligence.

The above-described present disclosure may be implemented as computer readable code in a computer readable recording medium in which programs are recorded. Computer readable recording media may include all kinds of recording media in which data readable by computers is stored. The computer readable recording media may include a Hard Disk Drive (HDD), a Solid State Disk (SSD), a Silicon Disk Drive (SDD), a ROM, a RAM, a CD-ROM, a magnetic tape, a floppy disk, and an optical data storage device, and may be implemented as a carrier wave (for example, transmission over the Internet).

The computer may include a processor or a controller. The above description has been made only for a better understanding of the present disclosure and is not interpreted restrictively. Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. An electronic apparatus for vehicles, comprising a processor configured to:
receive sensor data including an image of the outside of a vehicle;
identify a danger-factor from the sensor data through a first learning model;
learn a danger determination criterion depending on the danger-factor through a second learning model; and
generate a warning signal for warning a user of presence of the danger-factor when the danger-factor satisfies the danger determination criterion.

2. The electronic apparatus for vehicles according to claim 1, wherein the processor is configured to:
generate one or more corresponding control methods depending on the danger-factor through a third learning model; and
learn a corresponding control method due to a user input signal from the one or more corresponding control methods.

3. The electronic apparatus for vehicles according to claim 2, wherein the processor is configured to generate a corresponding control signal for controlling at least one vehicle drive apparatus of a steering control apparatus, a brake control apparatus or an acceleration control apparatus depending on the corresponding control method due to the user input signal.

4. The electronic apparatus for vehicles according to claim 3, wherein the processor is configured to calculate a safety grade of the corresponding control method due to the user input signal, based on position information, speed information and status information of the vehicle changed due to the corresponding control signal.

5. The electronic apparatus for vehicles according to claim 4, wherein the processor is configured to: select, in an autonomous driving mode, a corresponding control method having a highest safety grade learned through the third learning model, from the one or more corresponding control methods; and
control the at least one vehicle drive apparatus according to the corresponding control method having the highest safety grade.

6. The electronic apparatus for vehicles according to claim 5, wherein the first learning model, the second learning model and the third learning model comprise a Deep Neural Network (DNN) model of learning position information and time information.

7. The electronic apparatus for vehicles according to claim 6, wherein the processor is configured to:
when the danger-factor identified through the first learning model satisfies the danger determination criterion learned through the second learning model, display an icon stored depending on a kind of the danger-factor and the corresponding control method having the highest safety grade learned through the third learning model, on a Head Up Display (HUD) through augmented reality.

8. The electronic apparatus for vehicles according to claim 7, wherein the processor is configured to
transmit information about the danger-factor to one or more peripheral vehicles using Vehicle to Vehicle (V2V) communication on generating the warning signal.

9. The electronic apparatus for vehicles according to claim 1, wherein the processor is configured to:
identify kinds of objects, comprising kinds of vehicles, and kinds of lanes from the image of the outside of the vehicle through the first learning model; and
learn a degree of risk depending on the kinds of the objects and the kinds of the lanes through the second learning model.

10. The electronic apparatus for vehicles according to claim 9, wherein the processor is configured to:
digitize the degree of risk; and
generate the warning signal for displaying the kind of the object and the digitized degree of risk and a warning signal for displaying a color stored according to the degree of risk through RGB LEDs installed in the vehicle when the digitized degree of risk is a set value or more.

11. The electronic apparatus for vehicles according to claim 1, wherein the processor is configured to:
identify a vehicle changing lanes without operating turn signal, or a vehicle driving without keeping its lane, from a rear image of the vehicle through the first learning model;
acquire an image of a rear vehicle driver through a camera; and
learn a status of the rear vehicle driver from the image through the second learning model, and
wherein the status of the rear vehicle driver comprises an eye blinking speed or a gaze direction.

12. The electronic apparatus for vehicles according to claim 11, wherein the processor is configured to:
determine that the rear vehicle driver is in a drowsy driving state when the eye blinking speed of the rear vehicle driver is a set value or less;
determine that the rear vehicle driver is in a state neglecting forward attention when the gaze direction of the rear vehicle driver is not a forward direction; and
generate a warning signal for displaying the drowsy driving state or the state neglecting forward attention.

13. The electronic apparatus for vehicles according to claim 1, wherein the processor is configured to:
identify a damaged road surface and a kind of a lane, from a front image of the vehicle through the first learning model; and
learn a degree of shaking of the vehicle during driving on the road through the second learning model.

14. The electronic apparatus for vehicles according to claim 13, wherein the processor is configured to:
when the degree of shaking of the vehicle is a set value or more,
store the front image of the vehicle together with position information;
generate a first warning signal when the vehicle enters the position information within a predetermined distance; and
generate a second warning signal when the damaged road surface is identified from the front image of the vehicle.

15. The electronic apparatus for vehicles according to claim 1, wherein the processor is configured to:
identify at least one of a kind of a truck or a degree of symmetry of cargo loaded on the truck from a front image of the vehicle though the first learning model; and
learn height information due to the kind of the truck or a degree of shaking of the truck due to the degree of symmetry of the cargo loaded on the truck through the second learning model.

16. The electronic apparatus for vehicles according to claim 15, wherein the processor is configured to:
when the height information is a value, set depending on the kind of the truck, or more, or the degree of shaking of the truck is a set value or more,
calculate a danger radius based on the height information and the degree of shaking, the danger radius being a fall range of the cargo from the truck; and
generate a warning signal for displaying the truck and the danger radius.

17. The electronic apparatus for vehicles according to claim 1, wherein the processor is configured to:
identify a front vehicle being decelerated from a front image of the vehicle through the first learning model; and
learn whether a brake light is operated due to deceleration of the front vehicle through the second learning model.

18. The electronic apparatus for vehicles according to claim 17, wherein the processor is configured to:
upon determining that the brake light of the front vehicle is not operated during deceleration of the front vehicle, display the brake light of the front vehicle as being turned on during deceleration of the front vehicle through augmented reality (AR); and
generate a warning signal for indicating a defect of the brake light.

19. The electronic apparatus for vehicles according to claim 1, wherein the processor is configured to:
identify at least one vehicle of a vehicle changing lanes without operating a turn signal, a vehicle operating an emergency brake, a vehicle driving beyond a reference speed, or a vehicle not assuring a safe distance through the first learning model;
learn a driving pattern of the identified vehicle through the second learning model; and
generate a warning signal for displaying presence and a position of a recklessly driving vehicle when the identified vehicle is determined as the recklessly driving vehicle.

20. The electronic apparatus for vehicles according to claim 1, wherein the processor is configured to:
identify a movable object through the first learning model;
learn an emergence frequency of the movable object depending on time and section information through the second learning model; and
generate a warning signal for displaying the time and section information and the movable object being capable of emerging when the emergence frequency of the movable object is a set value or more.
